(19) United States
(12) Patent Application Publication
(10) Pub. No.: US 2015/0013514 A1
(43) Pub. Date: Jan. 15, 2015

(54) METHOD AND APPARATUS FOR IMPROVING CUTTING TABLE PERFORMANCE

(71) Applicant: ANGEL ARMOR, LLC, Fort Collins, CO (US)

(72) Inventor: Eric B. Strauss, Fort Collins, CO (US)

(21) Appl. No.: 14/497,276

(22) Filed: Sep. 25, 2014

Related U.S. Application Data
(63) Continuation-in-part of application No. 14/322,931, filed on Jul. 3, 2014.
(60) Provisional application No. 61/882,973, filed on Sep. 26, 2013.
(60) Provisional application No. 61/903,337, filed on Nov. 12, 2013.
(60) Provisional application No. 61/842,937, filed on Jul. 3, 2013.

(51) Int. Cl. B26D 7/01; B26D 1/04; B26D 7/00

(52) U.S. Cl. CPC B26D 7/018; B26D 7/0006; B26D 7/015; B26D 1/045
USPC 83/29; 269/21; 83/451; 83/13; 83/39

(57) ABSTRACT

A buffer layer can be used in conjunction with a cutting table to reduce cutting tool wear. During use, a first surface of the buffer layer can rest on a top surface of the cutting table, and a second surface of the buffer layer can receive a material to be cut. The buffer layer can include one or more channels in its second surface, and the one or more channels can correspond to a pattern to be cut from the material. The depth of the one or more channels can be sufficient to provide a clearance depth between a tip of the cutting tool and a bottom surface of each of the one or more channels. The clearance depth can prevent the tip of the cutting tool from wearing against the bottom surface of the channels, thereby increasing life expectancy of the cutting tool and reducing process costs.

### CROSS-CITE TO RELATED APPLICATIONS

This application claims the benefit of U.S. Provisional Patent Application No. 61/882,973 filed on Sep. 26, 2013, the contents of which is hereby incorporated by reference in its entirety as if fully set forth below. This application is a continuation-in-part of U.S. patent application Ser. No. 14/322,931 filed on Jul. 3, 2014, which claims the benefit of U.S. Provisional Application No. 61/842,937, filed Jul. 3, 2013, and U.S. Provisional Application No. 61/903,337, filed Nov. 12, 2013, each of which is hereby incorporated by reference in its entirety as if fully set forth below.

### BACKGROUND

Cutting tables are commonly used in garment factories to facilitate large scale cutting of materials, such as fabrics. Cutting tables are often large, flat surfaces that are well-suited for handling sheets of fabric while patterns are cut from the fabric. To prevent the fabric from moving during a cutting process, the cutting table can be equipped with a vacuum system. The vacuum system can include a plenum located beneath the cutting table, and the plenum can be in fluid communication with small holes or pores in the cutting table. The vacuum system can include a vacuum pump in fluid communication with the plenum. When the vacuum pump is operating, it can draw air through the perforations in the cutting table, into the plenum, and through the vacuum pump. When a sheet of fabric is being cut on the cutting table, operation of vacuum pump produces a partial vacuum in the plenum, which creates a suction force on a top surface of the cutting table, and that suction force prevents the material from moving during the cutting process, thereby improving cutting precision.

### BRIEF DESCRIPTIONS OF DRAWINGS

FIG. 1 shows a cutting table with a cutting head attached to computer controlled gantry.

FIG. 2 shows a carriage assembly attached to a gantry.

FIG. 3 shows a cutting tool mounted to a cutting head attached to a carriage assembly.

FIG. 4 shows vacuum system located beneath a cutting table and in fluid communication with the cutting table.

FIG. 5 shows a partial top perspective view of a buffer layer with a plurality of channels and a plurality of air passages disposed in the buffer layer.

FIG. 6 shows a cross-sectional side view of a cutting process employing a cutting table, a buffer layer, and a vacuum system.

FIG. 7 shows a cross-sectional side view of a cutting process involving a buffer layer with a channel and a cutting table.

FIG. 8 shows a cross-sectional side view of a cutting process involving a buffer layer with cavities and air dams.

FIG. 9 shows a prior art method of using a bristled material with a cutting table.

FIG. 10A shows a downward piercing force being applied to a cutting tool in a z-direction to pierce a material positioned on a buffer layer with channels.

FIG. 10B shows a lateral drag force being applied to the cutting tool of FIG. 10A after the cutting tool has pierced the material and as the cutting tool follows a first cutting pathway during a first cutting step.

FIG. 10C shows a lateral drag force being applied to a cutting tool after the cutting tool has pierced a stack of sheets of material and as the cutting tool follows a first cutting pathway during a first cutting step.

FIG. 11 shows a cross-sectional side view of a cutting process involving a cutting table and a buffer layer with a channel.

FIG. 12 shows a cross-sectional side view of a cutting process involving a buffer layer, a protective layer, and a cutting table.

FIG. 13 shows a cross-sectional side view of a cutting process employing a buffer layer and a vacuum system without a cutting table surface.

FIG. 14 shows a cross-sectional side view of a cutting table assembly including a buffer layer positioned on top of a cutting table and a filter positioned between the buffer layer and the cutting table.

FIG. 15 shows a cutting table assembly with a material to be cut positioned on top of a buffer layer and a plurality of overlapping cutting pathways shown as dotted lines on a top surface of the material to be cut.

FIG. 16 shows a cutting table assembly with a material to be cut positioned on top of a protective layer (with no buffer layer) and a plurality of overlapping cutting pathways shown as dotted lines on a top surface of the material to be cut.

FIG. 17 shows a lateral drag force being applied to a cutting tool after the cutting tool has pierced a stack of sheets of material and as the cutting tool follows a first cutting pathway during a first cutting step, where a protective sheet is provided between the stack and the cutting table to protect the cutting table and the cutting tool from wear.

### DETAILED DESCRIPTION

The solutions described herein provide many advantages over existing methods and apparatuses for cutting materials on a cutting table. For instance, the solutions described herein can significantly increase cutting tool life by reducing wear imparted on a cutting tool by a cutting table surface. The solutions described herein can improve overall cutting efficiency by reducing downtime needed for tooling changes and can reduce process costs by reducing the frequency of cutting tool replacement. The solutions described herein can permit thicker materials to be cut than was possible with conventional approaches. The solutions described herein can also permit multiple layers of materials to be cut simultaneously in a stacked configuration, thereby increasing production rates while simultaneously reducing production costs.

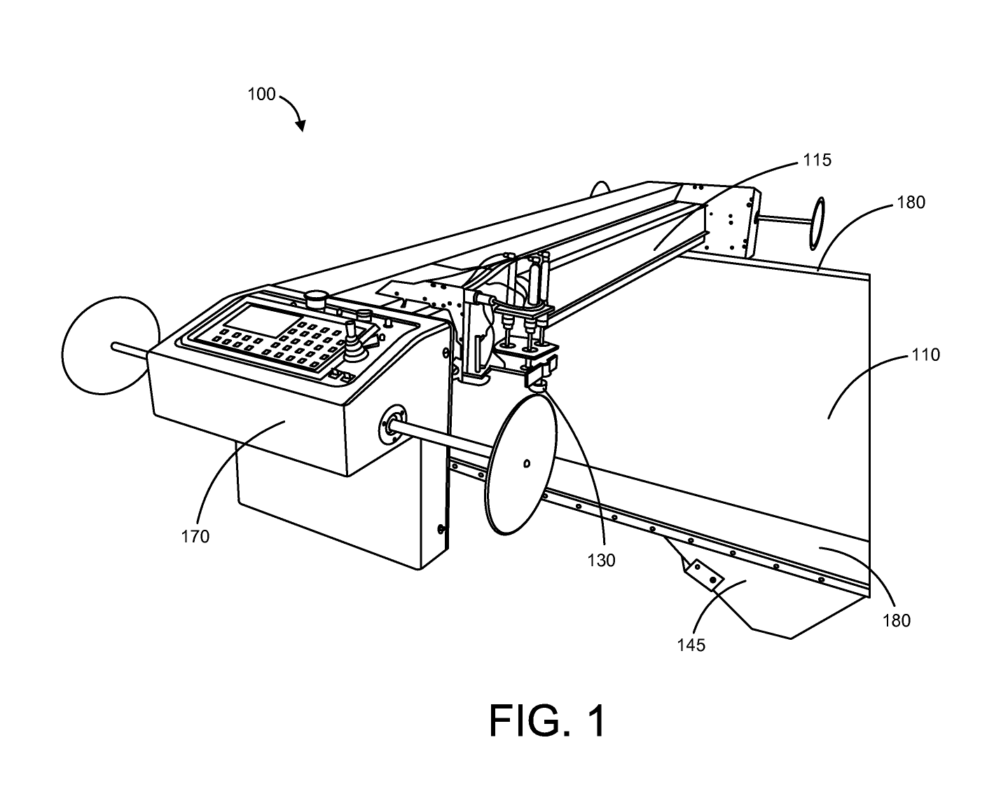

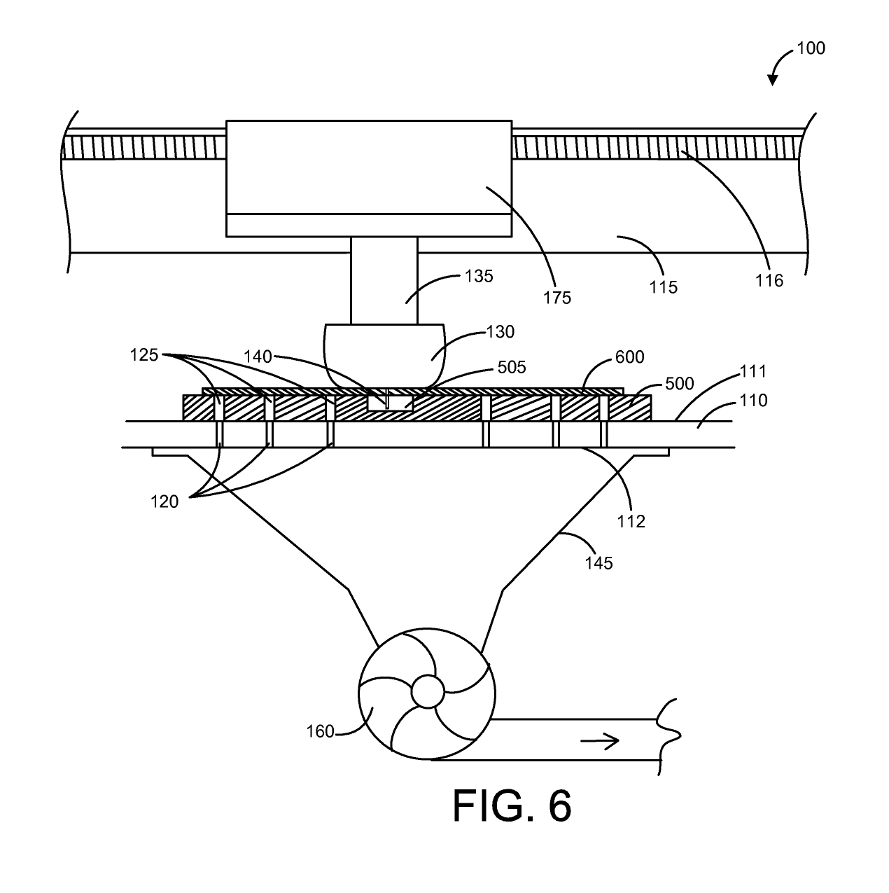

A cutting table assembly 100, as shown in FIGS. 1, 6, and 14, can be used to cut a wide variety of fabrics for garments or other applications. In one example, the cutting table assembly 100, as shown in FIGS. 1, 6, and 14, can be used to cut ballistic resistant fabrics for ballistic resistant vests, panels, or other apparatuses. The cutting table assembly 100 can include a cutting table 110 having a top surface 111 and a bottom surface 112 with a plurality of holes 120 extending through the cutting table (i.e. from the top surface to the bottom surface of the cutting table). The plurality of holes 120 in the cutting table 110 can be drilled, as shown in FIG. 6, or can be formed by any other suitable process. Alternately, the holes 120 in the cutting table 110 can be pores, such as pores in a porous cutting table material. For example, the cutting table 110 can be formed from a layer of porous polymer material, such as the POREX Vacuum Hold-Down Sheet available from Porex Corporation of Fairburn, Ga. The porous polymer material can be sufficiently porous (i.e. air permeable) to allow air to be drawn through the material by a vacuum pump 160. The porous polymer material can have a relatively high Rockwell hardness to withstand repeated scoring from a mechanical cutting tool, such as a razor blade (e.g. drag knife) or rotary blade. The porous polymer material can also have an open pore structure that minimizes vacuum losses by imparting a relatively low back pressure on the vacuum pump 160, thereby resulting in a greater suction force at the top surface of the cutting table for a given power input to the vacuum pump. Reducing back pressure exerted on the vacuum pump can reduce the load demanded from an electric motor coupled to and driving the vacuum pump, thereby increasing the life expectancy of the electric motor and thereby reducing overall manufacturing costs.

The cutting table 110 can be equipped with a vacuum system, which can include a plenum 145 connected to a vacuum pump 160, as shown in FIG. 6. The plenum can be 145 installed beneath the cutting table 110. The plenum 145 can be in fluid communication with the plurality of holes (e.g. drilled holes, perforations, pores, etc.) 120 in the cutting table. The term “fluid communication” as used herein can describe any ducting or other suitable air handling components that permit air to flow from a first component to a second component. As used herein, “fluid communication” between two or more elements refers to a configuration in which fluid can be communicated between or among the elements and does not preclude the possibility of having a filter, flow meter, or other devices disposed between such elements.

The vacuum pump 160 can be placed in fluid communication with the plenum 145, such as with ducting components, as shown in FIG. 6. During a cutting process, a material 600 (e.g. a workpiece, a sheet of material, a layer of material, multiple sheets of a single material, or multiple sheets of two or more materials) can be placed on a top surface 111 of the cutting table 110 and held in place by a suction force created by the vacuum pump 160 as the vacuum pump draws air through the plurality of holes 120 in the cutting table 110 and produces a partial vacuum (i.e. a pressure below atmospheric pressure) in the plenum 145 and proximate the holes 120 in the top surface 111 of the cutting table. An example of a cutting table assembly 100 that can be equipped with a vacuum system is the M9000 Static Cutting Table, manufactured by Eastman Machine Company of Buffalo, N.Y. An example of a cutting table assembly is shown in FIG. 1.

In some examples, the top surface 111 of the cutting table 110 can be made from a durable material such as soapstone, a porous polymer material (e.g. POREX), granite, slate, thermoplastic polycarbonate (e.g. LEXAN), or hardened steel. Preferably, the top surface 111 of the cutting table 110 is made from a material that is not easily damaged by cutting tools (e.g. drag knives or rotary blades) and retains its flatness over time to permit consistent cutting as well as a suitable life expectancy.

Cutting a material 600 directly on the cutting table 110 can cause rapid wear of the cutting tool 140, since the cutting table 110 is commonly made of a relatively hard material, and because downward pressure must be applied to the cutting tool 140 to force it against the cutting table to ensure a clean cut through the material being cut. Consequently, direct and prolonged contact of the cutting tool against the cutting table can result in rapid wear of the cutting tool (e.g. drag knife).

As the cutting tool 140 wears, its performance deteriorates and the cutting tool will eventually need to be replaced. In other instances, the cutting tool 140 may simply break during use as a result of considerable stresses placed on the cutting tool during cutting, resulting in stress concentrations that result in physical failure of the cutting tool. In either case (i.e. wear or breakage), the cutting tool 140 will need to be replaced with a new blade, and the cutting table assembly 100 will experience downtime while an operator replaces the broken or worn blade. When the cutting tool fails, scrap material 600 often results due to unfinished cuts or unsatisfactory cut quality. This can be particularly common when cutting composite materials (e.g. ballistic sheets) having woven fibers or sheets made of unilateral fibers, since a dull blade may fail to sever high strength fibers (e.g. aramid fibers or ultra-high-molecular-weight polyethylene fibers) completely and may instead pull the fibers from the composite material, thereby producing scrap material that cannot be used for its intended purpose. For many reasons, it is desirable to avoid rapid wear, and frequent replacement, of the cutting tool 140.

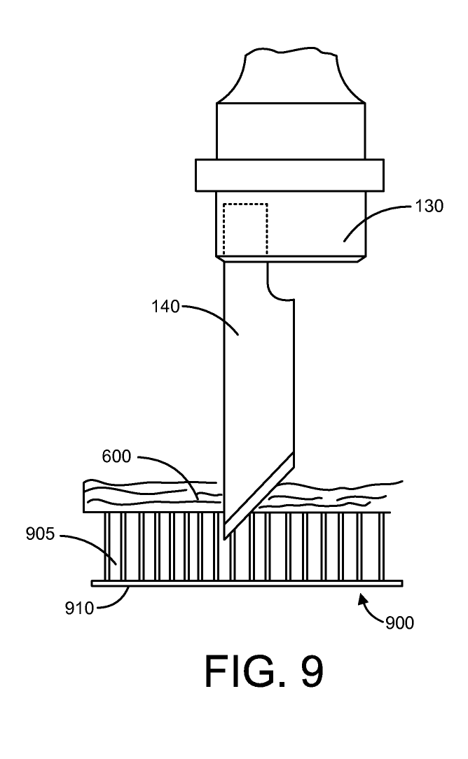

A prior art method to limit wear of the cutting tool 140 exists, but is useful only for cutting thin textile materials. In the prior art method, the top surface of a cutting table 110 is covered with a bristled 900 material as shown in FIG. 9. The bristled material 900 can include a plurality of synthetic bristles 905 extending vertically from a base sheet 910. In one example, the bristles 905 can be about 0.5 mm thick and about 5 mm in length. The bristled material 900 can be air-permeable to allow air to be drawn through the bristles 905 and base sheet 910 and into the plurality of holes 120 in the cutting table 110. The bristled material can serve two important functions. First, the bristled material 900 can improve cutting precision by restricting unwanted lateral movement of the textile material 600 by providing a significant amount of friction that resists movement of the material being cut 600 even as the cutting head 130 traverses the bristled material. Second, the bristled material can provide a recess beneath the textile material for a drag knife 140 to extend into during a cutting process. The recess can be sufficiently deep to prevent the drag knife 140 from contacting the hard cutting table 110 beneath the bristled material as it traverses the textile material during a cutting process. Because the drag knife 140 does not contact the cutting table 110 directly during the cutting process, unnecessary wear and dulling of the drag knife can be avoided.

The prior art method described above and shown in FIG. 9 is suitable for thin, easy-to-cut materials, such as lightweight fabrics commonly used for garments. However, the prior art method is not suitable for cutting certain materials where more cutting force is required. For instance, the prior art method is not suitable for cutting difficult-to-cut materials such as certain plastics or composite materials (e.g. carbon-fiber reinforced polymers, glass-fiber reinforced polymers, stacks of multiple ballistic sheets) where greater cutting force is required. A wide variety of ballistic materials containing aramid fibers are commercially available. Specifically, TechFiber, LLC, located in Arizona, manufactures a ballistic material sold under the trademark K-FLEX; Polystrand, Inc., located in Colorado, manufactures a ballistic material sold under the trademark POLYSTRAND; and DuPont, headquartered in Delaware, manufactures a ballistic material sold under the trademark TENSYLON. The apparatuses and methods described herein are capable of cutting the above-mentioned materials with precision and ease and at a relatively low cost compared to competing methods, such as die cutting.

If a user attempts to cut a difficult-to-cut material using the prior art method, the amount of downward force required to puncture and cut the material with a drag knife 140 will result in compression of the bristles 905 and downward deflection of the material being cut, which will decrease cutting precision and, if compression of the bristles 905 exceeds a certain threshold, will result in the drag knife 140 contacting the cutting table 110, causing wear and dulling of the drag knife and possible breakage. Consequently, the prior art method does not permit cutting of certain difficult-to-cut materials while also preventing the drag knife 140 from contacting the cutting table 110.

Another downside of the prior art method is that periodic replacement of the bristled material is required. When using a cutting table 110, it is common to cut a common pattern from a series of sheets of fabric. When a common pattern is cut from a series of sheets of fabric positioned on the bristled material, the cutting head 130 will trace the same pathway for each sheet, resulting in the same pathway being traced many times during a production run. The synthetic bristles on the bristled material will become damaged by the repeated passing of the drag knife 140, which is razor sharp, and as a result, the performance and structure of the bristles will be degraded over time. Eventually, the bristled sheet will need to be replaced.

In view of the shortcomings of the prior art method, it was desirable to develop a new method that allows a wide variety of materials, such as fabrics, plastics, and composite materials to be cut with efficiency and precision while avoiding unnecessary dulling, breakage, and replacement of the drag knife 140 (e.g. a blade mounted to the cutting head 130). Plastic and composite materials can include dry composites, pre-impregnated composite materials (such as pre-impregnated composite materials manufactured by Polystrand, TechFiber), ultra-high-molecular-weight polyethylene (UHMWPE) fabrics (such as those manufactured by DuPont and BAE), fiberglass-polyester blended fabrics, as well as many others. To avoid unnecessary dulling and breaking of the drag knife 140, a buffer layer 500 can be inserted between the top surface of the cutting table 110 and the material being cut. The buffer layer 500 can prevent the drag knife 140 from contacting the top surface of the cutting table and thereby extend the life of the drag knife and reduce the frequency of drag knife replacement.

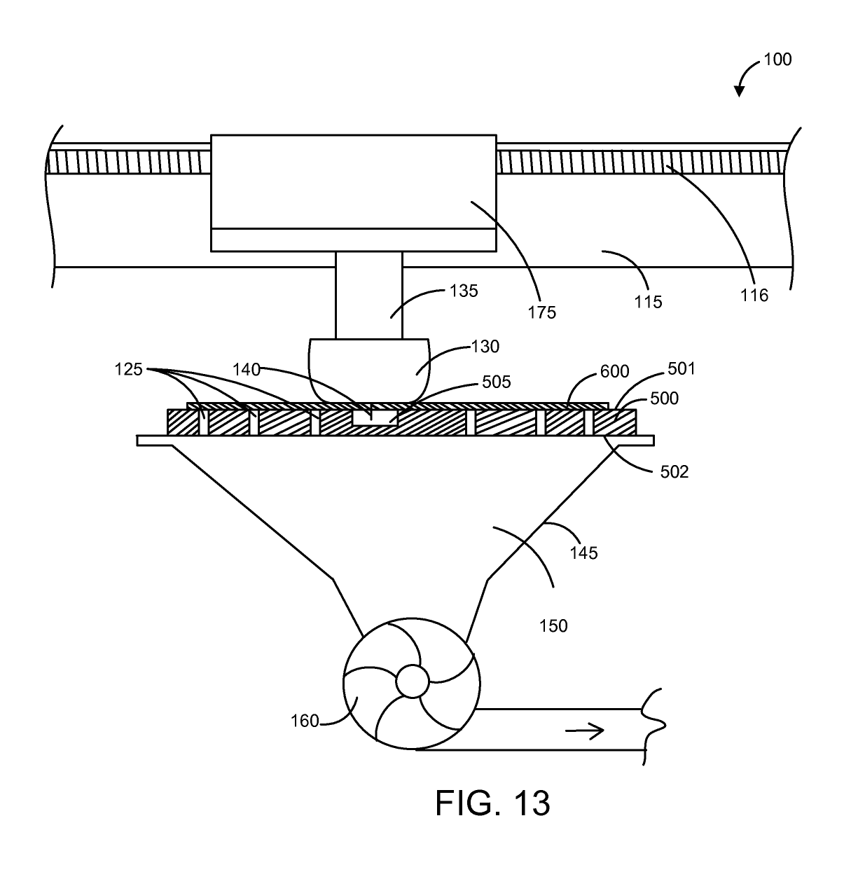

In another example, where the buffer layer 500 is sufficiently rigid to avoid sagging or deflection during a cutting process, the surface of the cutting table 110 can be removed entirely, and the buffer layer can serve as and replace the cutting table surface, as shown in FIG. 13. Since the cutting table surface is commonly a precision-made component, it represents a significant fraction of the overall cost of the cutting table assembly 100. Avoiding purchasing the cutting table surface 110 represents a significant cost savings to a company preparing to implement the apparatuses and methods described herein.

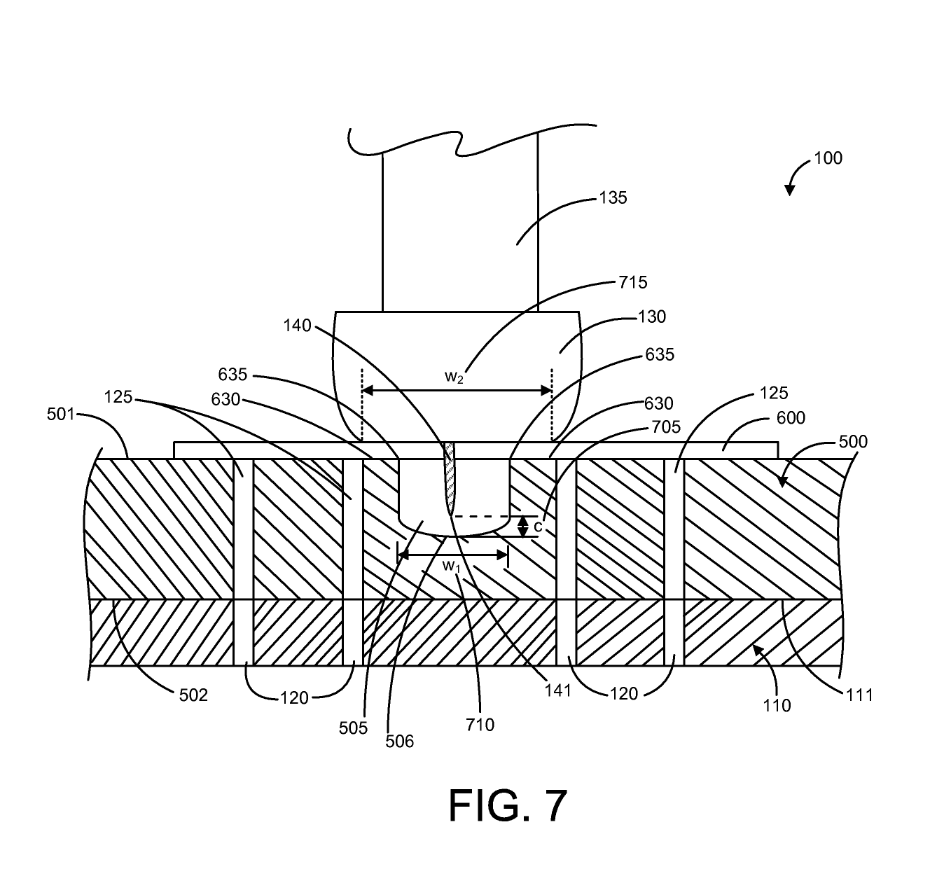

The buffer layer 500 can include a top side 501 and a bottom side 502. In some examples, during use, as shown in FIG. 7, the bottom side 502 of the buffer layer 500 can be placed against the top surface 111 of the cutting table 110, and the top side of the buffer layer 501 can be configured to receive and support the material to be cut 600, such as, for example, one or more layers of fabric, a polymer sheet, or a composite material. The buffer layer 500 can include a plurality of air passages 125 extending through the buffer layer from the top side 501 of the buffer layer to the bottom side 502 of the buffer layer. The plurality of air passages 125 can permit air to be drawn through the buffer layer 500 and into the plurality of holes 120 (or pores) in the cutting table 110 by the vacuum pump 160, as shown in FIG. 6. The vacuum pump 160 produces a partial vacuum (i.e. a pressure below atmospheric pressure) in the plenum 145, which produces a suction force proximate the top side 501 of the buffer layer 500 as air is drawn through the air passages 125 in the buffer layer and into the plurality of holes 120 in the cutting table 110. The suction force can hold the material 600 being cut against the top surface 501 of the buffer layer 500 during the cutting process, thereby improving cutting precision.

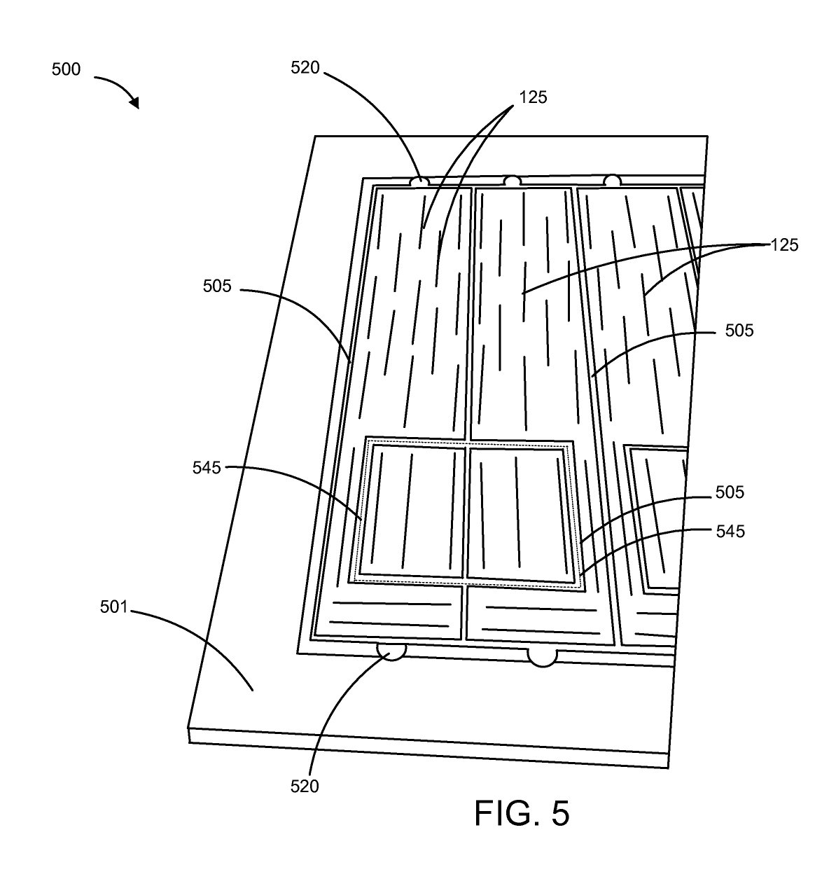

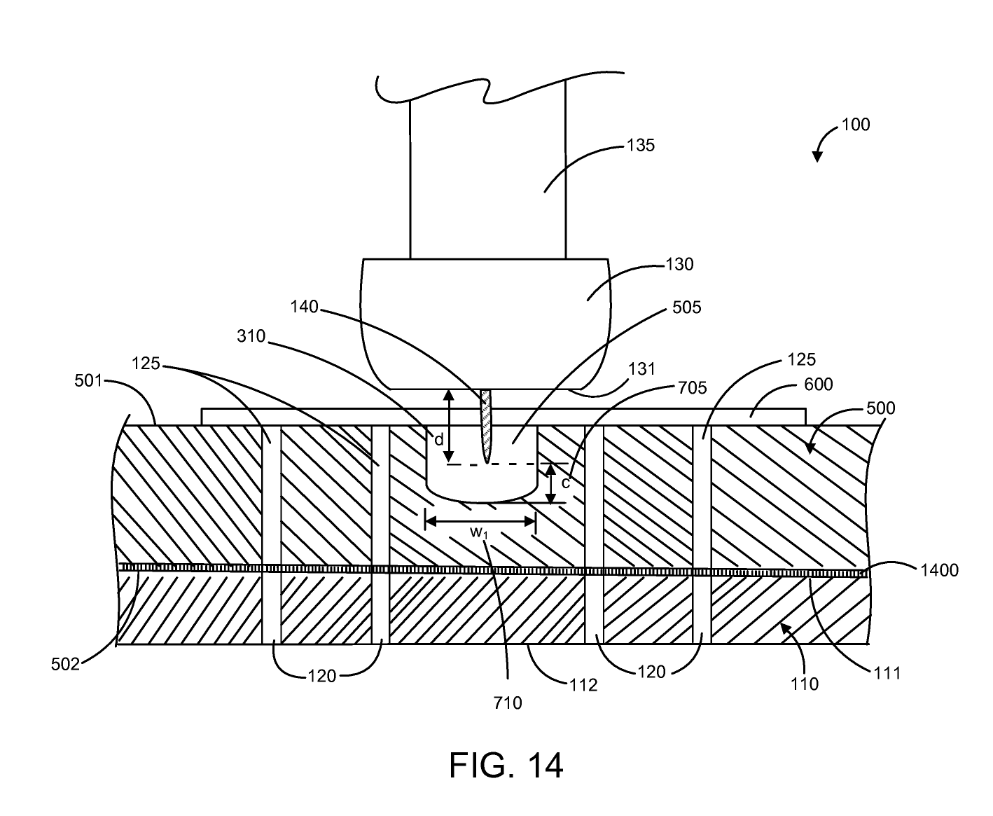

In some examples, the air passages 125 in the buffer layer 500 can be slots in the buffer layer as shown in FIG. 5. Alternately, the air passages 125 can have any other suitable shape. In certain examples, the air passages 125 can be drilled holes, machined openings, routered openings, sawed slots or openings, cast passages, punched holes, die cut holes, or laser cut passages. In another example, the air passages 125 can be openings in a 3-D printed buffer layer. The air passages 125 can have any suitable size and quantity that permits adequate air flow through the air passages at desired locations relative to the material to be cut 600 while not being overly restrictive such that operation of the vacuum pump 160 is impeded to a point of damaging the electric motor of the vacuum pump. In some examples, the air passages 125 can be sufficiently narrow or small to prevent cutting remnants (e.g. strands of fiberglass, strands of KEVLAR or other aramid fibers, pieces of cured epoxy, or pieces of hardened resins or other materials) from passing through the air passages and clogging the plurality of holes 120 in the cutting table 110 and restricting air flow through the cutting table. In some examples, each air passage 125 can have a width that is smaller than each hole in the plurality of holes 120 to effectively filter and capture any cutting remnants thereby preventing the cutting remnants from passing through the air passages and clogging the plurality of holes 120 in the cutting table 110 and restricting air flow through the cutting table. In some examples, a filter 1400, such as a layer of filter material, can be inserted between the buffer layer 500 and the top surface 111 of the cutting table 110, as shown in FIG. 14. The filter 1400 can have a high degree of air permeability thereby permitting air to be freely drawn through the filter. However, the filter 1400 can be configured to capture any cutting remnants that are inadvertently drawn through the air passages 125 in the buffer layer 500. In some example, the filter 1400 can be made of a nylon material, similar to nylon scouring pad material or open cell foam. In other examples, the filter 1400 can be made of felt, fabric, perforated paper or polymer sheets, or any other suitable material capable of effectively filtering cutting remnants that are inadvertently drawn through the air passages 125 in the buffer layer 500.

In one example, the buffer layer 500 can be made of a porous material (e.g. porous polymer material), and the air passages 125 can be established by porosity in the buffer layer so that a separate manufacturing process (e.g. milling, drilling, punching, sawing, carving, etc.) may not be required to create the air passages. In another example, the buffer layer 500 can include a lattice structure, and the air passages can exist between adjacent members of the lattice structure.

In yet another example, the buffer layer 500 can be formed by 3D printing. Any suitable 3D printing process can be used to form the buffer layer 500. For instance, a fused deposition modeling (FDM) process can be used to form the buffer layer 500. During the FDM process, a plastic filament or metal wire can be unwound from a coil and supplied to an extrusion nozzle that heats and melts the filament. The extrusion nozzle can move in X, Y, and Z directions by, for example, a computer controlled mechanism employing stepper motors in conjunction with a computer-aided manufacturing (CAM) software package. The buffer layer 500 can be formed by extruding small beads of thermoplastic material (e.g. polycarbonate) to form layers of thermoplastic material. The thermoplastic material can harden shortly after extrusion from the extrusion nozzle, thereby forming a hard, durable buffer layer 500. In another example, 3D printing can be accomplished by stereolithography (SLA), which can be accomplished by depositing thin layers of an ultraviolet curable material sequentially to build the buffer layer 500.

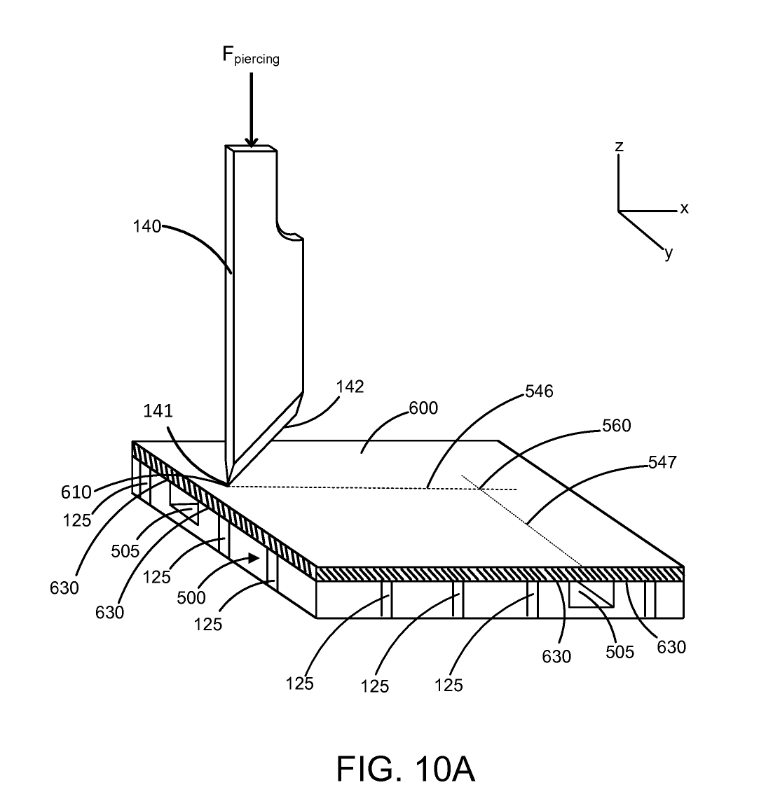

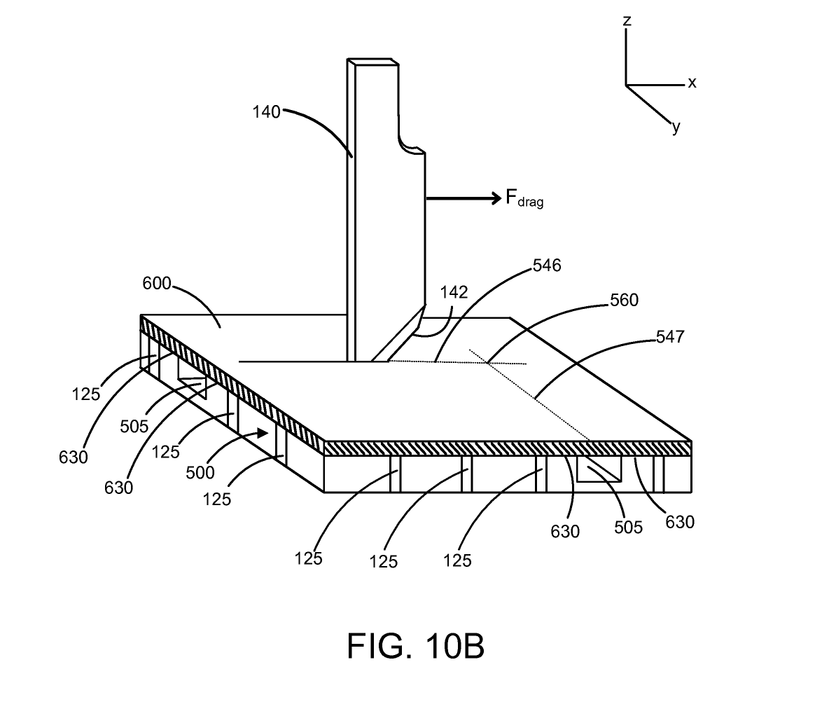

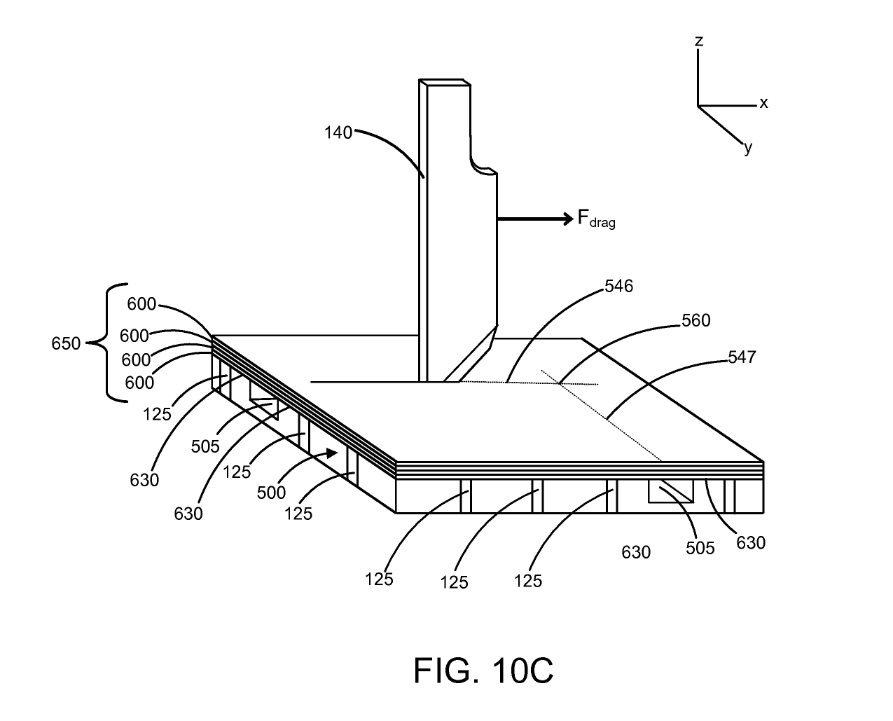

As shown in FIG. 5, the top side 501 of the buffer layer 500 can include one or more channels 505. The one or more channels 505 can link together to form a pathway 545 that corresponds to a pattern to be cut from the material 600. The shape and arrangement of the one or more channels 505 can define the shape of the pathway 545 the cutting tool 140 can follow while cutting the pattern from the material 600. In one example, the cutting tool 140 can follow a rectangular pathway 545, as shown by dotted lines in FIG. 5, that corresponds to a rectangular pattern. In this example, the pathway 545 is defined by four channels 505 having linear shapes and interconnected to form a rectangular pathway. Consequently, by following the pathway 545 shown in FIG. 5 during a cutting process, the cutting tool 140 can cut a rectangular pattern from the material 600 positioned on top of the buffer layer 500. Although only rectangular-shaped pathways 545 are shown in FIG. 5, this is not limiting. The one or more channels 505 can have any suitable shape or combination of shapes (e.g. linear, curved, round, elliptical, polygonal, nonuniform, etc.), and arrangement, to form any shape of pathway 545 to accommodate any suitable pattern to be cut from the material 600. In some examples, two or more channels 505 can be interconnected to form a cutting pathway 545 corresponding to a pattern to be cut from the material 600. In other examples, a single continuous channel 505 can define a cutting pathway 545 corresponding to a pattern to be cut from the material 600. By providing a single continuous channel 505, the pattern can be cut from the material with only one piercing process, which may improve life expectancy of the cutting tool and can reduce process time. This approach can be suitable for patterns having curved edges. Where the pattern has sharp corners, as shown in FIG. 10B where the first and second cutting pathways (546, 547) are perpendicular to each other, more than one piercing process may be required to provide a cleanly cut corner 560.

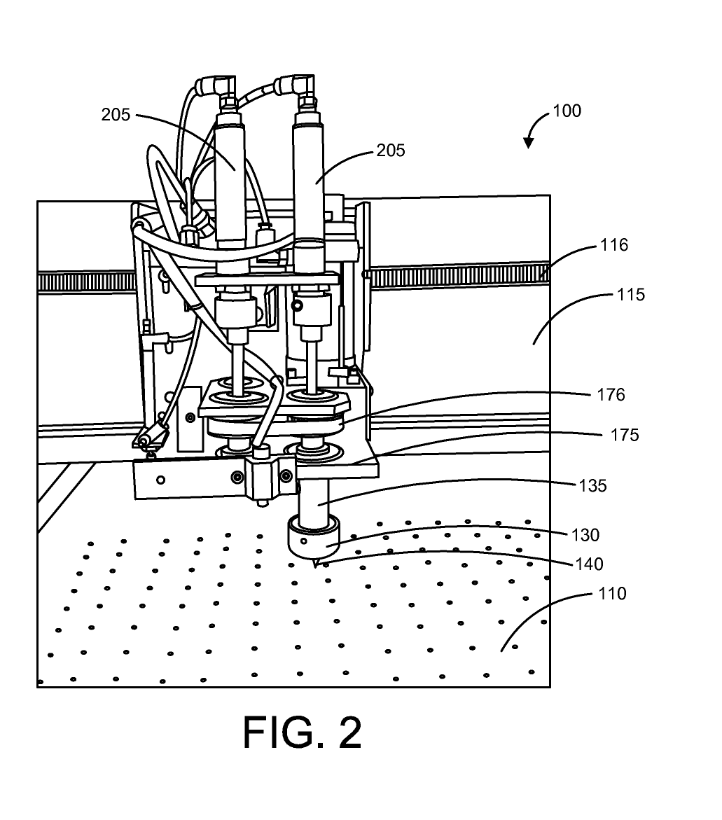

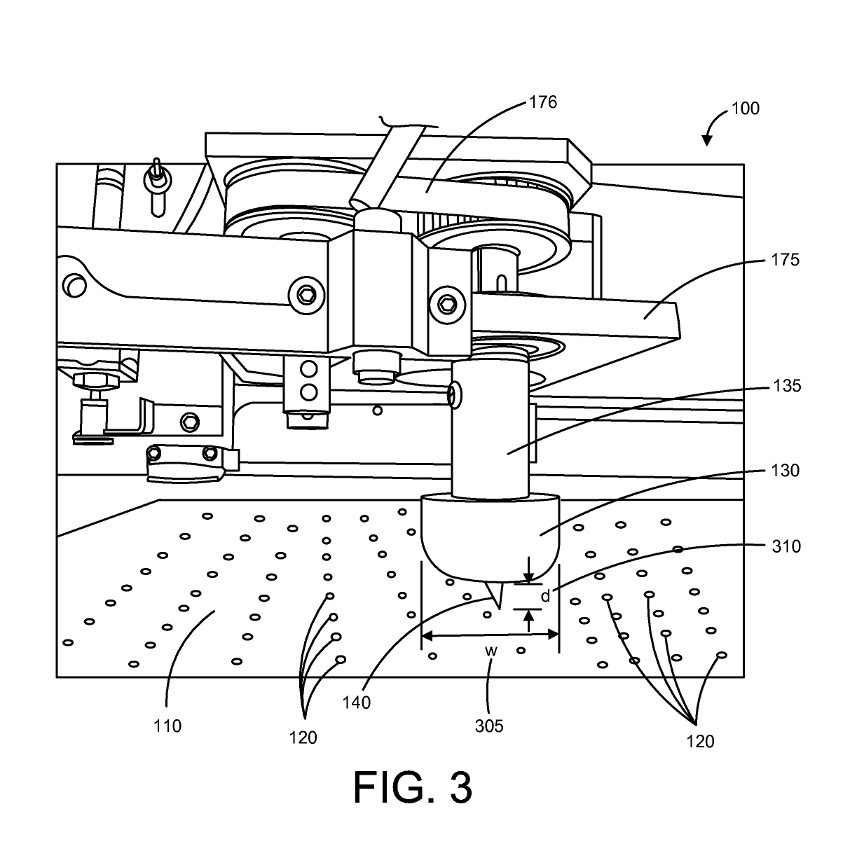

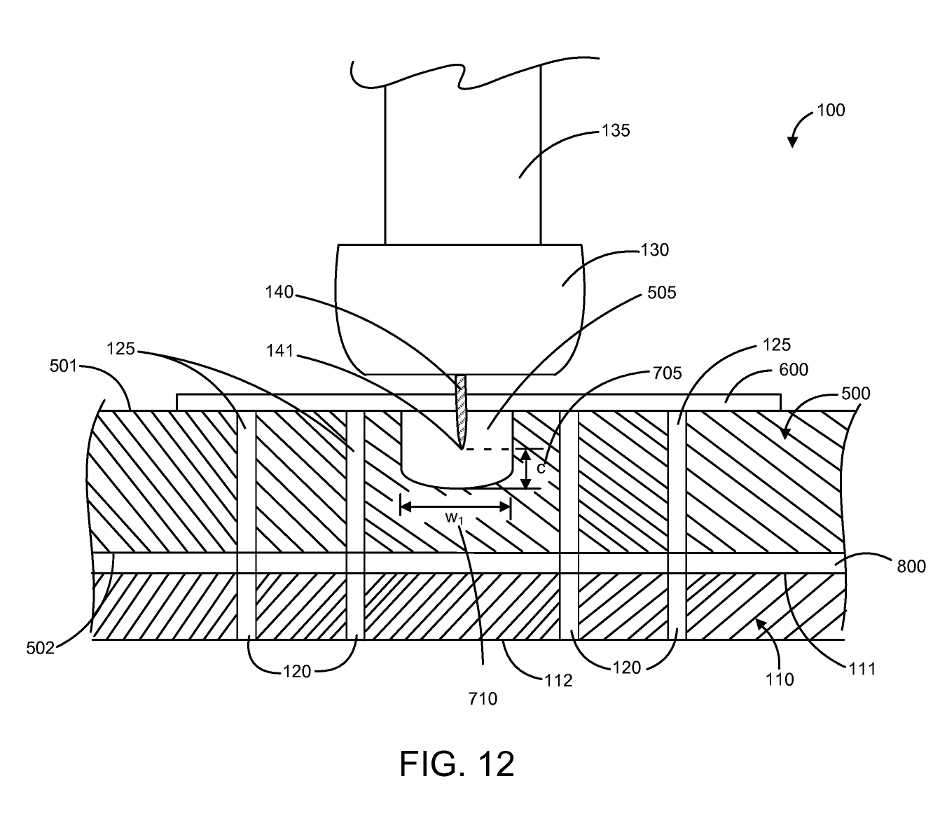

In some examples, the cutting tool 140 can be controlled to execute a series of two or more distinct cutting steps along one or more channels 505 to effectively trace all portions of a cutting pathway 545, thereby facilitating cutting of a pattern from the material 600. For instance, for the cutting pathway 545 shown in dotted lines in FIG. 5, the cutting table assembly 100 can be programmed to execute four distinct cutting steps using the cutting tool 140 (e.g. one cut along each channel 505). During a first cutting step, the cutting tool 140 can be programmed to move downward to pierce the material 600, stopping prior to the tip 141 of the cutting tool 140 making contact with the bottom surface 506 of the channel 505, thereby avoiding wear or damage to the cutting tool. An example of a suitable plunge depth of the cutting tool 140 is shown in FIG. 12, where a clearance depth (c) remains between the tip 141 of the cutting tool 140 and the bottom surface 506 of the channel 505. Once the cutting tool 140 has pierced the material 600, the gantry assembly 115 can facilitate movement of the cutting tool 140 from a first location (x₁, y₁) to a second location (x₂, y₂). Once the cutting tool 140 reaches the second location, the cutting tool 140 can lift upward (e.g. in a z direction) and away from the cutting pathway 545, thereby withdrawing the cutting tool from the channel 505 and away from the material 600, and thereby completing the first cutting step. Once the cutting tool 140 is no longer in contact with the material 600, the cutting head 130 can rotate, for example, in response to actuation of the servo motor 205 that is connected to the spindle 135 by a toothed belt 176, as shown in FIGS. 2 and 3. Rotating the cutting tool 140 about a z-axis can facilitate a second cutting step along a second channel 505 that requires the cutting tool to cut the material 600 in a different direction than the direction of the first cutting step. Once the cutting tool 140 is properly oriented, the second cutting step can proceed similarly to the first cutting step. Subsequent cutting steps can be performed until the cutting tool 140 has effectively traced all portions of the cutting pathway 545, thereby completing the series of distinct cutting steps resulting in the desired pattern being cleanly cut free from the material 600.

For certain materials, such as ballistic sheets 600 made of high strength fibers, it can be desirable for a second pathway 547 of a second cutting step to overlap a first pathway 546 of a first cutting step, as shown in FIGS. 10A-C and 15-17. This approach can ensure a cleanly cut corner 560 for the pattern of material 600 proximate the overlapping cutting pathways (546, 547). Cleanly cut corners can be desirable when cutting ballistic sheets for inclusion in ballistic resistant panels. When constructing ballistic resistant panels, it is desirable to produce a panel that has consistent ballistic performance throughout the panel. If ballistic sheets with poorly cut corners are included in the ballistic resistant panel, the ballistic performance will vary across the panel, resulting in a panel that will not pass certification testing and must be destroyed.

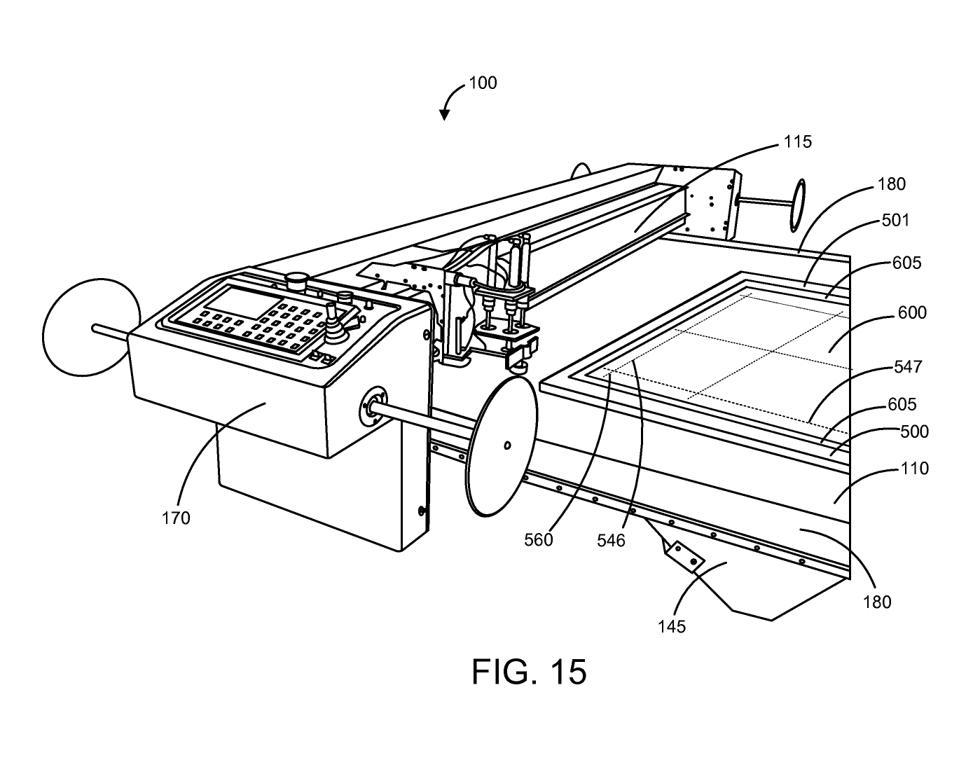

In some examples, as shown in FIG. 15, it may be desirable to secure the edges of the material 600 to be cut, for example, with tape 605 to prevent the material from moving during the cutting process. Tape 605, or any other suitable adhesive, clamping device, or fasteners, can be used in conjunction with the vacuum system or instead of the vacuum system to hold the material 600 in place. In some instances where a vacuum system may not be permitted, such as in cleanroom when cutting components for microelectronics, tape 605, or any other suitable adhesive, clamping device, or fasteners, may be substituted to secure the material 600 to the buffer layer 500 or protective layer 800 while cutting the material with the cutting table 110.

To facilitate easy removal of cut materials 600 from the top surface 501 of the buffer layer 500, the buffer layer can include one or more finger recesses 520, as shown in FIG. 5. The finger recess 520 can permit a user to insert a finger beneath an edge of the material 600 to allow the material to be lifted more easily from the buffer layer. The finger recess 520 can be particularly useful when the vacuum system is operating and a suction force is being applied to the material 600 being picked from the buffer layer 500 after cutting is complete. This scenario may be encountered when the vacuum system is not turned off between cuttings of successive sheets of material during a production run.

Each channel 505 can have a depth that is sufficient to prevent the cutting tool 140 from contacting a bottom surface 506 of the channel 505 during a cutting process, such as the cutting process shown in FIG. 10B. The cutting tool 140 can have a depth (d) 310, as shown in FIGS. 3 and 14. The depth (d) 310 of the cutting tool 140 can be measured from the bottom surface 131 of the cutting head 130 to the tip 141 of the drag knife 140. In some instances, the cutting tool (e.g. drag knife) 140 can have a depth (d) that results in the tip 141 of the cutting tool extending about 0.010-1.0, 0.02-0.05, 0.125-0.50, 0.375-0.5, or about 0.5 inches beneath a bottom surface of the material 600 being cut. In some examples, and depending on the depth (d) of the cutting tool, the depth of the channel 505 in the buffer layer 500 can be at least 0.02, 0.05, 0.125, 0.375, 1.0, or at least 0.5 inches to prevent the tip 141 of the cutting tool 140 from contacting a bottom surface 506 of the channel 505 during the cutting process. As shown in FIG. 7, a clearance depth (c) 705 can be provided between the bottom surface 506 of the channel 505 and the tip 141 of the cutting tool 140. The clearance depth (c) 705 can be any suitable distance to prevent unwanted contact of the cutting tool 140 against the bottom surface 506 of the channel 505. The necessary clearance depth (c) 705 to ensure that the cutting tool 140 does not inadvertently make contact with the bottom surface 506 of the channel 505 may depend on the material 600 being cut and the cutting rate at which the cutting head 130 moves relative to the material 600 being cut, since the cutting head height may experience greater variability at higher cutting rates than at lower cutting rates. In certain scenarios, the clearance depth (c) 705 measured between the bottom surface 506 of the channel 505 and the tip 141 of the cutting tool 140 can be about 0.005-2.0, 0.02-1.5, 0.04-1.0, or 0.5-1.0 inches. Larger clearance depths (c) 705 can also be used, but in the interest of having a relatively thin and lightweight buffer layer 500 that can be installed on and removed from the cutting table 110 relatively easily by a single operator without a mechanical assisting device, smaller clearances depths (c) 705 may be preferable.

Before cutting in the X or Y directions can occur, the cutting tool 140 must first pierce the material 600 in the Z direction, as shown in FIG. 10A. Piercing is accomplished by the cutting head 130, which the cutting tool 140 is fastened to, moving downward in the Z direction, thereby causing the cutting tool 140 to be forced into the material being cut 600. While piercing the material 600, the cutting tool 140 may experience a significant compression force in the Z direction. Because the cutting tool 140 is thinnest near its tip 141, the force concentration may be greatest at the tip. Consequently, the tip 141 of the cutting tool 140 may be susceptible to failure during the piercing process. By providing a channel 505 beneath the cutting tool 140, instead of the hard cutting table, the cutting tool 140 will experience a lower compression force and stress concentration compared to a conventional cutting process where a hard cutting table is present directly beneath the piercing location in the material 600 being cut. Once the cutting tool 140 pierces the material and begins cutting the material, as shown in FIG. 10B, the tip 141 of the cutting tool will experience no compression force. In contrast, when a cutting tool 140 is cutting directly against the hard cutting table, the tip 141 of the cutting tool will be exposed to a compression force for the entire duration of the lateral cutting process.

By using the buffer layer 500 described herein, the tip 141 of the cutting tool 140 may be exposed to a lower compression force in the z-direction while piercing the material 600, as shown in FIG. 10A. The tip 141 of the cutting tool 140 may be exposed to little or no compressive force in the z-direction during lateral cutting of the material, as shown in FIG. 10B, since the cutting tool may only exposed to the drag force (F_{drag}) applied by the cutting head 130 and an equal and opposite force applied along the leading edge 142 of the cutting tool by the material being cut 600. Consequently, the tip of the cutting tool 140 is exposed to lower compression forces and reduced wear during repetitive cutting processes. The buffer layer 500 described herein can effectively increase the useful lifespan of the cutting tool 140, thereby reducing downtime and reducing costs associated with replacement of broken cutting tools.

FIG. 10A shows a cutting tool 140 preparing to pierce the material 600, which is resting on a buffer layer 500 having channels 505 positioned beneath a first cutting pathway 546 and a second cutting pathway 547. The buffer layer 500 can include a plurality of air passages 125 extending from a lower surface of the buffer layer to an upper surface of the buffer layer. During a cutting step of a cutting process, the cutting tool 140 may experience a maximum stress concentration at the tip 141 of the cutting tool as the cutting tool moves downward in a z-direction at the beginning of the cutting step as the cutting tool pierces the material. Using a buffer layer 500 with a channel 505 positioned beneath a piercing location 610 where the tip 141 of the cutting tool pierces the material 600 can reduce the maximum piercing force (F_{piercing}) that must be applied to the cutting tool during the piercing process to effectively pierce the material 600, thereby increasing the lifespan of the cutting tool 140. Experimental testing has shown significantly greater tool lifespans when the buffer layer 500 with channels 505 is used during the cutting process as opposed to cutting directly on the hard surface 111 of the cutting table 110.

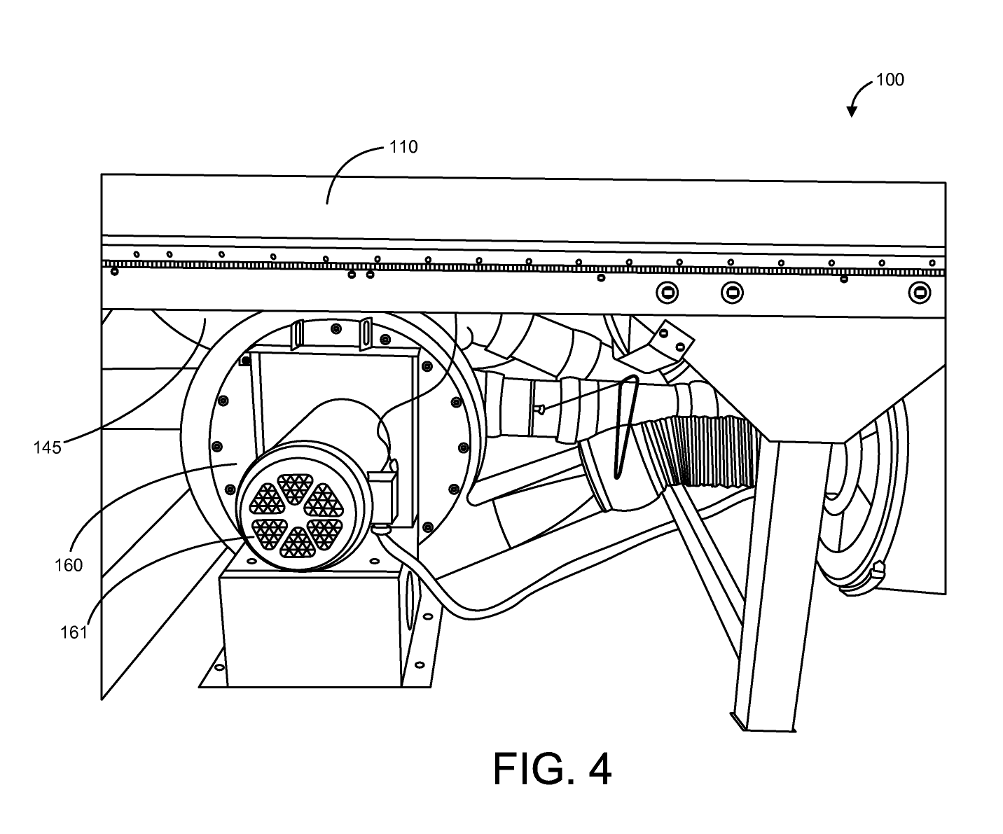

As shown in FIG. 10B, the buffer layer 500 can facilitate cutting of a single sheet of material 600 positioned on top of the buffer layer and held in place by vacuum pressure created at the plurality of air passages 125 along the top surface of the buffer layer, for example, by a vacuum system associated with a cutting table assembly 100, as shown in FIG. 4. As shown in FIG. 10C, the buffer layer 500 can facilitate cutting a plurality of sheets of material 600 arranged in a stack and positioned on top of the buffer layer. Whether cutting a single sheet of material 600 or multiple sheets of material, the one or more channels 505 in the buffer layer 500 can be configured to provide a clearance depth (c) between the tip 141 of the cutting tool 140 and the bottom surface 506 of the one or more channels.

In prior art cutting processes, signs of crater wear on the leading edge 142 of the cutting tool 140 is undesirable, since it indicates that the cutting tool is near the end of its useful life. Typically, when crater wear is observed, the cutting tool 140 will be replaced as soon as the operator has an opportunity. However, due to the low piercing force (F_{piercing}) experienced by the cutting tool 140 when utilizing the buffer layer 500 as described herein, a cutting tool 140 that displays visible signs of crater wear on its leading edge 142 can continue to be used, often for significant periods of time before failing and with a high level of cutting performance. This extended available life of the cutting tool 140 further adds to the overall increased tool life and cost savings that are possible by using the buffer layer 500 as described herein.

The buffer layer 500 can include a support region 630 proximate an upper edge 635 of the channel 505, as shown in FIG. 7. The buffer layer 500 can include a support region 630 proximate each of two upper edges 635 of the channel 505. Each support region 630 can be a flat or relatively flat surface located beside the channel 505 on the top side 501 of the buffer layer 500. In one example, the support region 630 can be present on both sides of the channel 505. In another example, the support region 630 may only be present on one side of the channel 505. In some examples, the material 600 to be cut can rest on the support regions 630, and during cutting, the cutting head 130 can press downward against the material and, in turn, press the material against the support regions, thereby securing a portion of the material between the bottom surface of the cutting head and the top surface 501 of the buffer layer 500 as the cutting head traverses the material during a cutting operation. By securing the material 600 on opposing sides of the cutting location 610, the support regions 630 can permit the material 600 being cut to resist downward deflection into the channel 505. The cutting tool 140 is therefore able to cut the material 600 without having to move further downward (in the z direction) to accommodate downward deflection of the material into the channel 505. Consequently, the cutting tool 140 can operate safely within the channel 505 without risk of the cutting tool striking the bottom surface of the channel 505 or the cutting table 110. Therefore, unlike prior art methods, the methods and apparatuses described herein permit cutting flexible materials, such as ballistic sheets, without risk of damaging the tip 141 of the cutting tool 140.

To permit the cutting head 130 to apply pressure against the material 600 and in turn against the support regions 630, the cutting head can have a width (w₂) 715 that is greater than the width of the channel (w₁) 710, as show in FIG. 7. The width (w₂) 715 of the cutting head 130 can be determined by the width of a portion of the cutting head 130 that physically contacts the material 600 during cutting. In one example shown in FIG. 7, the cutting head 130 can have a bottom surface with a rounded perimeter to promote smooth traversal of the cutting head over the material 600. Consequently, the width (w₂) 715 may be less than a maximum width measured elsewhere on the cutting head 130.

As noted above, the cutting head 130 can have a width (w₂) 715 that is greater than the width of the channel (w₁). For example, the cutting head 130 can have a width (w₂) 715 that is about 1-5, 5-15, 15-30, or at least 30% greater than the width (w₁) 710 of the channel 505. The additional width (w₂−w₁) of the cutting head 130 can provide a downward pressure that stabilizes the material 600 against the support regions 630 during the cutting process. The presence of the support regions 630 can greatly diminish downward deflection of the material 600 into the channel 505. As a result of there being little or no downward deflection of the material 600 into the channel 505, a cleaner cut is achieved (e.g. with less collateral damage to the material in the vicinity of the cut). This approach can permit more accurate cutting to be achieved, which yields tighter tolerances and allows certain materials 600, which previously required die cutting or other more costly processes, to be effectively cut on the cutting table 110 quickly and at a low cost.

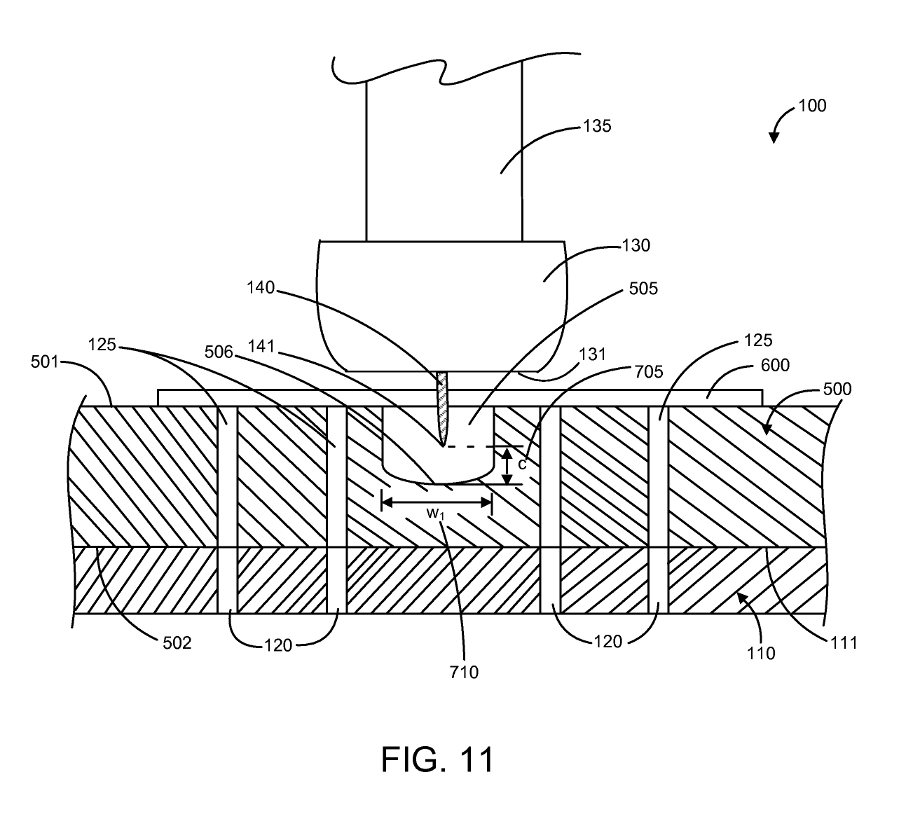

In some examples, as shown in FIGS. 11 and 14, the bottom surface 131 of the cutting head 130 may not contact the material 600 being cut during the cutting process and such contact may not be required to achieve a high quality cut. For instance, when the material 600 being cut is a relatively stiff material, such as a composite fabric for ballistic applications (e.g. ballistic sheet material) or a polymer or composite sheet material, downward pressure by the bottom surface 131 of the cutting head 130 against the top surface of the material 600 may not be needed. Instead, the bottom surface 131 of the cutting head 130 can be suspended a distance above the top surface of the material 600 during the cutting process, as shown in FIG. 11. In this example, a buffer layer 500 with a channel 505 having a clearance depth (c) 705 measured between the bottom surface 506 of the channel 505 and the tip 141 of the cutting tool 140 is utilized and ensures that the tip of the cutting tool does not strike or wear against the bottom surface of the channel, either during a plunging operation or during a lateral cutting step. In some examples, the clearance depth (c) 705 can be about 0.005-2.0, 0.02-1.5, 0.04-1.0, or 0.5-1.0 inches. By maintaining the cutting head 130 a distance above the material 600 during the cutting process, surface wear on the bottom surface 131 of the cutting head 130 can be avoided and wear marks on the top surface of the material being cut 600 can also be avoided, which can be desirable for materials where surface finish is important, such as for carbon fiber composite materials where transparent resins are used.

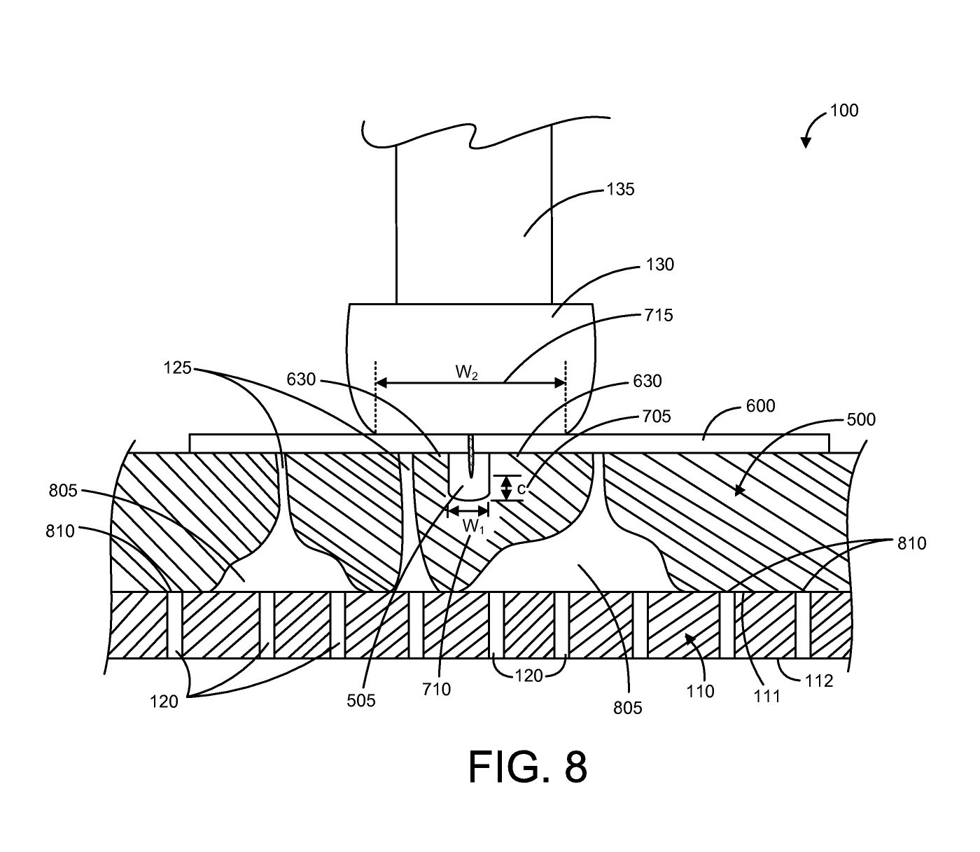

As shown in FIG. 8, the buffer layer 500 can include one or more cavities 805 on the bottom side 502 of the buffer layer. The cavities 805 can permit an air passage 125 in the buffer layer 500 to be in fluid communication with one or more holes 120 in the cutting table 110 without the air passage and the one or more holes needing to be perfectly aligned. As a result, a user can avoid spending time aligning air passages 125 and air holes 120 for the buffer layer 500 to work effectively when the vacuum system is operating. This feature can reduce changeover time between a first cutting process and a second cutting process, where the first cutting process requires a first buffer layer 500 configured to aid in cutting a first pattern from a first material 600 and a second buffer layer 500 configured to aid in cutting a second pattern from a second material 600.

In one example, the buffer layer 500 can cover most or all of the plurality of the holes 120 in the cutting table 110. The buffer layer 500 can include flat portions that serve as air dams 810, as shown in FIG. 8. The air dams 810 can prevent or restrict air from being drawn through certain holes in the cutting table 110 by covering those holes. By incorporating air dams 810, the buffer layer 500 can minimize air flow through certain holes 120 and encourage greater air flow through the remaining holes that are not restricted by air dams, which can effectively increase the partial vacuum exerted on a material resting against the air passages 125 that are in fluid communication with those remaining holes that are not restricted by air dams.

In another example, the cutting table 110 can include a zoning system for vacuum control. The cutting table 110 can be divided into a plurality of zones (e.g. 2-4, 4-8, or more than 8 zones), and the operator can control (e.g. enable or disable) vacuum independently at each zone. The zoning system can allow for cutting in one zone (e.g. where vacuum is applied) while the operator is simultaneously picking parts (e.g. patterns cut from the material 600) in another zone (e.g. where vacuum is reduced or disabled), which can improve process flexibility and production rates. The zoning system can be computer controlled or manually controlled. In one example, the zoning system can include a separate plenum 145 located beneath each zone and a control valve between each plenum and a common vacuum pump. Opening a first control valve can enable vacuum in a first zone, and closing the first control valve will disable vacuum in the first zone. Similarly, opening a second control valve will enable vacuum in a second zone, and closing the second control valve will disable vacuum in the second zone. If the zoning system is computer controlled, each control valve can be equipped with and actuated by a computer-controlled servomechanism. In another example, the zoning system can include a separate plenum beneath each zone and separate vacuum pump for each zone. Providing power to a first vacuum pump will enable vacuum in a first zone, and disabling power to the first vacuum pump will disable vacuum in the first zone. Similarly, providing power to a second vacuum pump will enable vacuum in a second zone, and disabling power to the second vacuum pump will disable vacuum in the second zone.

In some examples, each air passage 125 in the buffer layer 500 can include a filter (e.g. metal mesh, paper, synthetic mesh, or any other suitable type of filter) to restrict cutting remnants from reaching and clogging the plurality of holes 120 in the cutting table 110. The filters can be reusable or disposable. The filters can be removable from the buffer layer 500 to permit cleaning or replacement of the filters. The filters can be cleaned in an ultrasonic cleaner, with compressed air, with a vacuum, with solvents, or by any other suitable method. The filters can cover and attach to the air passages 125 in any suitable way. In one example, the filters can snap into the air passages 125 and can utilize an interference fit to remain in position. In another example, the filters can be attached to the buffer layer 500 using any suitable type of fastener. In yet another example, the buffer layer 500 can include a top portion and a bottom portion, and the filters can be sandwiched between the top and bottom portions. In some examples, the top portion can be attached to the bottom portion by a hinge located along an edge of the buffer layer 500. The hinge can allow for easy separation of the top and bottom portions during insertion or removal of the filters and can also ensure proper alignment of the top and bottom portions when the hinge is in a closed position.

The buffer layer 500 can be made of any suitable material. For example, the buffer layer 500 can be made of an engineered wood product (e.g. fiberboard, plywood, particle board), wood, thermoplastic polycarbonate (e.g. LEXAN), composite, bamboo, engineered bamboo, plastic, engineered cellulosic products (e.g. materials made from rye straw, wheat straw, rice straw, hemp stalks, kenaf stalks, or sugar cane), glass, metal, stone, etc. Certain engineered wood products, such as medium density fiberboard (MDF), can be inexpensive and recyclable, which are desirable attributes for the buffer layer 500. Fiberboard can be relatively lightweight, which permits the buffer layer 500 to be easily installed on a cutting table, often by just one person. Consequently, buffer layers 500 made of relatively lightweight fiberboard can reduce labor costs for cutting processes that require a changeover of buffer layers.

The plurality of holes 120 in the cutting table 110 can have any suitable size and can be arranged in any suitable array. In one example, the plurality of holes 120 can appear as small perforations arranged in a symmetrical grid on the cutting table 110, as shown in FIGS. 2 and 3. In another example, the plurality of holes 120 can be sized and spaced to customize the suction force within a certain area on the top surface 111 of the cutting table 110 to accommodate a particular pattern being cut from a material 600 (e.g. by concentrating a suction force beneath the pattern being cut).

A cutting operation can involve manual or automated cutting of a material 600. In one example shown in FIG. 1, the cutting table assembly 100 can include a computer control system 170 that permits computer numeric control (CNC) of the cutting tool 140. The computer control system 170 can be configured to receive instructions relating to cutting coordinates (e.g. x, y), cutting velocities (e.g. ft/sec), and cutting acceleration and deceleration (e.g. ft/sec²). The computer control system 170 can be connected to a personal computer running a software program with a graphical user interface that allows an operator to input instructions that are delivered to the computer control system 170.

A cutting head 130 can be configured to receive and hold the cutting tool 140, as shown in FIG. 3. FIG. 3 shows a side view of the cutting tool 140 whereas FIGS. 6-8 and 11-14 show a rear view of the cutting tool. In one example, the cutting head 130 can include a collet to permit easy installation and removal of the cutting tool 140. The cutting tool 140 can be any suitable tool configured to cut, mark, drill, or punch a material 600 positioned on the cutting table 110. In one example, the cutting tool 140 can be a drag knife. In another example, the cutting tool 140 can be a rotary blade.

The cutting head 130 can be supported by a carriage assembly 175, as shown in FIGS. 2 and 3. The carriage assembly 175 can provide multi-axis motion of the cutting head 130 relative to the cutting table 110. In one example, the carriage assembly 175 can be mounted to a gantry assembly 115, as shown in FIG. 1, that permits movement of the cutting head 130 in X and Y directions, where an X direction corresponds to lengthwise movement of the cutting head relative to the cutting table 110, and a Y direction corresponds to crosswise movement of the cutting head relative to the cutting table. To facilitate crosswise movement of the cutting head 130, the gantry assembly 115 can include a rack and pinion gear system or other suitable gear system. The rack 116, shown in FIG. 2, can be integrated into the gantry assembly 115, and the pinion gear can be attached to a servomotor 205. To facilitate lengthwise movement of the cutting head 130 and carriage assembly 175, the gantry assembly 115 can include two synchronized servomotors 205 that drive the gantry assembly on a pair of tracks 180 located on opposing edges of the cutting table 110, as shown in FIG. 1.

The spindle 135, shown in FIGS. 2 and 3, can move up and down to permit movement of the cutting head 130 in a Z direction. The spindle 135 can also rotate to permit repositioning of the cutting tool 140 for directional cutting, such as when using a drag knife 140. Rotation of the spindle 135 can be controlled by one or more servomotors 205 connected to the spindle by a toothed belt 176, as shown in FIGS. 2 and 3.

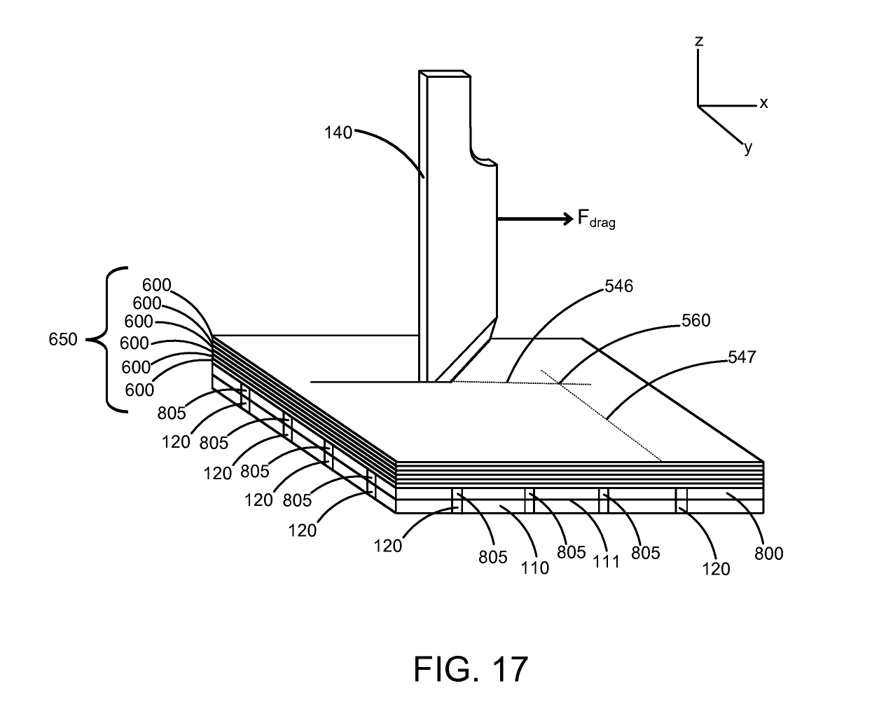

As shown in FIG. 7, the buffer layer 500 can be placed directly on the top surface 111 of the cutting table 110. In another example shown in FIG. 12, it can be desirable to insert a protective layer 800 between the buffer layer 500 and the cutting table 110. The protective layer 800 can prevent damage to the top surface 111 of the cutting table 110 caused by repeated use and changeover of buffer layers. In one example, the protective layer 800 can be made of a polymer material, such as a thermoplastic polycarbonate. The protective layer 800 can include a plurality of air holes 805 to permit air to be drawn through the protective layer, as shown in FIG. 17. In one example, the protective layer 800 can be a LEXAN sheet having an array of drilled holes 805 and a thickness of, for example, about 0.125-1.0, 0.25-0.5, 0.125-0.375, or 0.25-0.375 inches. Over time, the top surface of the protective layer 800 may deteriorate due to wear, for example, by frequent changeover of the buffer layer or due to mishaps with control of the cutting tool 140. Eventually, the protective layer 800 may need to be replaced. Fortunately, replacing the protective layer 800 is significantly less expensive than replacing the primary (i.e. top) surface of the cutting table 110. Consequently, over time, using a sacrificial protective layer 800 can significantly reduce production costs and can preserve the value of the cutting table 110 be preventing wear to the top surface 111 of the cutting table.

In one example, a buffer layer 500 can be adapted for use with a cutting table 110 equipped with a vacuum system. The buffer layer 500 can include a first surface 501 and a second surface 502 opposite the first surface. The second surface of the buffer layer 500 can be adapted to rest against a top surface 111 of a cutting table, as shown in FIG. 6, and the first surface of the buffer layer can be adapted to receive a material 600 to be cut. A channel 505 can be provided in the first surface of the buffer layer 500, and the channel can correspond to a pattern to be cut from the material 600. The channel 505 can have a depth adapted to provide a clearance depth (c) 705 between a cutting tool 140 and a bottom surface of the channel while the pattern is being cut from the material 600, as shown in FIG. 7. A plurality of air passages 125 can extend from the first surface to the second surface of the buffer layer 500. The plurality of air passages can be adapted to permit air to flow through the buffer layer 500 and into a plurality of holes 120 in the cutting table 110 when the vacuum system is operating.

The buffer layer 500 can include a support region 630 proximate a top edge of the channel 505. The support region 630 can be adapted to receive the material 600 to be cut. The support region 630 can be adapted to support the material 600 and resist downward deflection of the material into the channel 505 when downward pressure is applied by the cutting tool 140. In certain examples, the material 600 to be cut can be a carbon-fiber reinforced polymer, a glass-fiber reinforced polymer, or a stack of two or more ballistic sheets, and the material can have a thickness of at least 0.0625 inches.

As shown in FIG. 7, the width of the cutting head 130 can be greater than the width of the channel 505. In one example, the width (w₂) 715 of the cutting head 130 can be at least 10% greater than the width (w₁) 710 of the channel 505. The clearance depth (c) 705 between a tip 141 of the cutting tool 140 and the bottom surface of the channel 505 can be at least 0.020 inch.

The buffer layer 500 can include a cavity 805 extending into the second surface of the buffer layer, as shown in FIG. 8. The cavity 805 can be configured to permit a first air passage of the plurality of air passages 125 to be in fluid communication with a first hole of the plurality of holes 120 in the cutting table 110 even when the first air passage and the first hole are misaligned. This can be accomplished by the first air passage having a larger cross-sectional area proximate the second surface 502 of the buffer layer than the cross-sectional area of the first hole proximate the top surface of the cutting table 110, as shown in FIG. 8. Although FIG. 8 shows air passages 125 having cavities 805 with relatively complex shapes, a similar result can be achieved with much simpler shapes. For instance, air passages 125 that are slots, such as those shown in FIG. 5, are easy to manufacture, can span multiple holes 120 in the cutting table 110, and can provide excellent vacuum performance.

A method for cutting a material 600 on a cutting table 110 while preventing a drag knife 140 from contacting a surface 111 of the cutting table can include providing a cutting table and providing a buffer layer 500 positioned on the top surface of the cutting table. The cutting table 110 can include a top surface 111 and a bottom surface 112 opposite the top surface, as show in FIG. 6. The cutting table 110 can include a cutting tool 140 mounted to a carriage assembly 175 that is movable relative to the top surface 111 of the cutting table. The cutting table 110 can include a plurality of holes 120 extending from the top surface 111 to the bottom surface 111, a plenum 145 in fluid communication with the bottom surface of the cutting table, and a vacuum pump 160 in fluid communication with the plenum. The vacuum pump can be configured to produce a partial vacuum in the plenum 145 while operating, and as a result, to draw air through the plurality of holes 120 in the top surface of the cutting table 110. The buffer layer 500 can include a first surface 501 and a second surface 502 opposite the first surface. The second surface 502 of the buffer layer 500 can be adapted to rest against the top surface 111 of a cutting table 110, as shown in FIG. 6, and the first surface 501 of the buffer layer can be adapted to receive the material 600 to be cut. The buffer layer 500 can include a channel 505 in the first surface, and the channel can correspond to a pattern to be cut from the material 600. The channel 505 can have a depth configured to provide a clearance depth (c) 705 between a cutting tool 140 and a bottom surface of the channel while the pattern is being cut from the material, as shown in FIG. 7. The buffer layer 500 can also include a plurality of air passages 125 extending from the first surface to the second surface. The air passages can 125 in the buffer layer can be adapted to permit air to flow through the buffer layer 500 and into the plurality of holes 120 in the cutting table 110 when the vacuum system is operating.

A ballistic resistant panel can be made of one or more ballistic sheets 600. The term “sheet” or “material” as used herein, can describe one or more layers of any suitable material, such as a polymer, metal, fiberglass, or composite material, or combination thereof. Examples of polymers include aramids, para-aramids, meta-aramids, polyolefins, and thermoplastic polyethylenes. Examples of aramids, para-aramids, meta-aramids include NOMEX, KERMEL, KEVLAR, TWARON, NEW STAR, TECHNORA, HERACRON, and TEIJINCONEX. An example of a polyolefin is INNEGRA. Examples of thermoplastic polyethylenes include TENSYLON from E. I. du Pont de Nemours and Company, DYNEEMA from Dutch-based DSM, and SPECTRA from Honeywell International, Inc., which are all examples of ultra-high-molecular-weight polyethylenes (UHMWPE). Examples of types of glass fibers include A-glass, C-glass, D-glass, E-glass, E-CR-glass, R-glass, S-glass, and T-glass. Other suitable fibers include M5 (polyhydroquinone-diimidazopyridine), which is both high-strength and fire-resistant.

A ballistic sheet 600 can be constructed using any suitable manufacturing process, such as extruding, die cutting, forming, pressing, weaving, rolling, etc. The sheet can include a woven or non-woven construction of a plurality of fibers bonded by a resin, such as a thermoplastic polymer, thermoset polymer, elastic resin, or other suitable resin. In one example, the ballistic sheet 600 can include a plurality of aramid bundles of fibers bonded by a resin containing, for example, polypropylene, polyethylene, polyester, or phenol formaldehyde. The plurality of bundles of fibers in the ballistic sheet 600 can be oriented in the same direction, thereby creating a unidirectional fiber arrangement, known as a uni-ply ballistic sheet.

In some examples, the ballistic sheet 600 can include fibers that are pre-impregnated with a resin, such as thermoplastic polymer, thermoset polymer, epoxy, or other suitable resin. The fibers can be arranged in a woven pattern or arranged unidirectionally. The resin can be partially cured to allow for easy handling and storage of the ballistic sheet 600 prior to formation of the panel. To prevent complete curing (e.g. polymerization) of the resin before the sheet 600 is incorporated into a ballistic resistant panel, the ballistic sheet may require cold storage.

Certain ballistic sheets are described in U.S. Pat. No. 5,437,905, which is hereby incorporated by reference in its entirety. During a manufacturing process, bundles of fibers can be supplied from a plurality of yarn creels. The bundles of fibers can pass through a comb guide where the bundles of fibers are arranged in a parallel orientation and formed into an array and passed over a resin application roller where a resin film, such as a thin polyethylene or polypropylene film or other suitable film, is applied to one side of the array. The bundles of fibers may be twisted or stretched prior to passing over the resin application roller to increase their tenacity. A pre-lamination roller can then press the array of bundles of fibers against the resin film, which is then pressed against a heated plate, which causes the resin film to adhere to the array. After heating, the bundles of fibers and the resin film can be passed through a pair of heated pinch rolls to form a ballistic sheet. The ballistic sheet 600 can then be wound onto a roll.

Two ballistic sheets, having unidirectional arrangements of fibers (known as uni-ply), can be bonded together to produce a configuration known as x-ply. X-ply can include a first ballistic sheet 600 and a second ballistic sheet 600, each having a two-dimensional arrangement of unidirectionally-oriented fibers. The second ballistic sheet 600 can be arranged at a 90-degree angle with respect to the first ballistic sheet 600, which is set to a reference angle of 0-degrees. This configuration is known as 0/90 x-ply, where “0” and “90” denote the relative orientations (in degrees) of the bundles of fibers within the first and second ballistic sheets, respectively. The first ballistic sheet 600 can be laminated to the second ballistic sheet 600 in the absence of adhesives or bonding agents. Instead, a first thermoplastic film and second thermoplastic resin film can be bonded to the outer surfaces of the first and second ballistic sheets without penetration of the resin films into the bundles of fibers or through the laminated sheets from one side to the other. Through a process involving heat and pressure, the resin films melt and subsequently solidify to effectively laminate the uni-ply ballistic sheets to each other, thereby producing a 0/90 x-ply configuration.

Ballistic sheets constructed from high performance fibers, such as fibers made of aramids, para-aramids, meta-aramids, polyolefins, or ultra-high-molecular-weight polyethylenes, are commercially available from a variety of manufacturers. Several specific examples of commercially-available ballistic sheets made of high performance fibers are provided below. Ballistic sheets are commercially-available in many configurations, including uni-ply, 0/90 x-ply, and 0/90/0/90 double x-ply configurations. Ballistic sheeting material can be ordered in a wide variety of forms, including tapes, laminates, rolls, sheets, structural sandwich panels, and preformed inserts, which can all be cut to size during a manufacturing process.

TechFiber, LLC, located in Arizona, manufactures a variety of ballistic sheets made of aramid fibers that are sold under the trademark K-FLEX. One version of K-FLEX is made with KEVLAR fibers having a denier of about 1000 and a pick count of about 18 picks per inch. K-FLEX can have a resin content of about 15-20%. Different versions of K-FLEX may contain different resins. For instance, a first version of K-FLEX can include a resin (e.g. a polyethylene resin) with a melting temperature of about 215-240 degrees F., a second version of K-FLEX can include a resin with a melting temperature of about 240-265 degrees F., a third version of K-FLEX can include a resin with a melting temperature of about 265-295 degrees F., and a fourth version of K-FLEX can include a resin with a melting temperature of about 295-340. K-FLEX is available in uni-ply, 0/90 x-ply, and 0/90/0/90 double x-ply configurations.

TechFiber, LLC also manufactures a variety of unidirectional ballistic sheets made of aramid fibers that are sold under the trademark T-FLEX. Certain versions of T-FLEX can have a resin content of about 15-20% and can include aramid fibers such as TWARON fibers (e.g. model number T765). Different versions of T-FLEX may contain different resins. For instance, a first version of T-FLEX can include a resin (e.g. a polyethylene resin) with a melting temperature of about 215-240 degrees F., a second version of T-FLEX can include a resin with a melting temperature of about 240-265 degrees F., a third version of T-FLEX can include a resin with a melting temperature of about 265-295 degrees F., and a fourth version of T-FLEX can include a resin with a melting temperature of about 295-340 degrees F. T-FLEX is available in uni-ply, 0/90 x-ply, and 0/90/0/90 double x-ply configurations.

Polystrand, Inc., located in Colorado, manufactures a variety of unidirectional ballistic sheets made of aramid fibers that are sold under the trademark THERMOBALLISTIC. One version of THERMOBALLISTIC ballistic sheets are sold as product number TBA-8510 and include aramid fibers with a pick count of about 12.5 picks per inch. Other versions of THERMOBALLISTIC ballistic sheets are sold as product numbers TBA-8510X and TBA-9010X and include aramid fibers (e.g. KEVLAR fibers) and have a 0/90 x-ply configuration. The resin content of the THEMROBALLISTIC ballistic sheets can be about 10-20% or 15-20%. Different versions of THERMOBALLISTIC ballistic sheets may contain different resins. For instance, a first version of THERMOBALLISTIC ballistic sheets can include a resin with a melting temperature of about 225-255 degrees F., a second version of THERMOBALLISTIC ballistic sheets can include a resin (e.g. a polypropylene resin) with a melting temperature of about 255-295 degrees F., a third version of THERMOBALLISTIC ballistic sheets can include a resin (e.g. a polypropylene resin) with a melting temperature of about 295-330 degrees F., a fourth version of THERMOBALLISTIC ballistic sheets can include a resin with a melting temperature of about 330-355 degrees F., and a fifth version of THERMOBALLISTIC ballistic sheets can include a resin with a melting temperature of about 355-375 degrees F. One version of THERMOBALLISTIC ballistic sheets can include a polypropylene resin. THERMOBALLISTIC ballistic sheets are available in uni-ply, 0/90 x-ply, and 0/90/0/90 double x-ply configurations.

E. I. du Pont de Nemours and Company (DuPont), located in Delaware, manufactures a ballistic sheet material made of ultra-high-molecular-weight polyethylene fabric that is sold under the trademark TENSYLON. A Material Data Safety Sheet was prepared on Feb. 2, 2010 for a material sold under the tradename TENSYLON HTBD-09-A (Gen 2) by BAE Systems TENSYLON High Performance Materials. The Material Safety Data Sheet is identified as TENSYLON MSDS Number 1005, is publicly available, and is hereby incorporated by reference in its entirety. The ballistic sheets are marketed as being lightweight and cost-effective and boast low back face deformation, excellent flexural modulus, and superior multi-threat capability over other commercially available ballistic sheets. The ballistic sheet material can be purchased on a roll and can be cut into ballistic sheets having a size and shape dictated by an intended application.

Honeywell International, Inc., headquartered in New Jersey, manufactures a variety of ballistic sheets made of aramid fibers that are sold under the trademark GOLD SHIELD. One version of GOLD SHIELD ballistic sheets are sold under product number GN-2117 and are available in 0/90 x-ply configurations and have an areal density of about 3.24 ounces per square yard.

To increase production rates, it can be desirable to cut a pattern from two or more sheets of material 600 simultaneously. This can be accomplished by stacking two or more ballistic sheets prior to cutting the sheets. Cutting can be accomplished on a cutting table 110 with any suitable cutting tool 140, such as a laser, blade, drag knife, rotary knife, or die cutter. In one example the cutting tool 140 can be a drag knife mounted to a computer-controlled gantry. When a drag knife is used, a downward cutting force from the drag knife is applied against the stack of ballistic sheets and, in turn, against the top surface of the cutting table (or protective layer 800 of, for example, LEXAN, that covers and protects the top surface of the cutting table).

If two or more types of materials 600, such as ballistic sheets, are being cut simultaneously in a stack 650, the resulting cut quality of each ballistic sheet can depend on the arrangement of the ballistic sheets within the stack. Certain types of ballistic sheets that are less stiff suffer poor cut quality if placed on top of the stack 650. For instance, ballistic sheets that are less stiff may suffer poor cut quality, such as fraying along edges or fibers pulling from the sheets by the drag knife 140, which can compromise performance and structure of the cut sheets.

Through experimentation, it has been discovered that bounding a ballistic sheet 600 that is less stiff with ballistic sheets that are more stiff can provide better cut quality along an edge of the ballistic sheet that is less stiff and produce significantly less fraying or pulling of fibers at the edge of the less stiff ballistic sheet. In one example, a grouping of one or more ballistic sheets that are less stiff can be bounded on a top surface by a grouping of one or more ballistic sheets that are stiffer. Specifically, a stack 650 of ballistic sheets 600 that is suitable for cutting on a cutting table can include a first grouping of one or more stiffer ballistic sheets on top of a second grouping of one or more less stiff ballistic sheets. In another example, a grouping of one or more ballistic sheets 600 that are less stiff can be bounded on a top surface and a bottom surface by grouping of one or more ballistic sheets that are stiffer. Specifically, a stack 650 of ballistic sheets 600 that is suitable for cutting on a cutting table can include a first grouping of one or more stiffer ballistic sheets, a second grouping of one or more less stiff ballistic sheets, and a third grouping of one or more stiffer ballistic sheets.

The flexibility of commercially available ballistic sheets 600 varies. In relative terms, K-FLEX ballistic sheets can be less stiff than THERMOBALLISTIC ballistic sheets. K-FLEX ballistic sheets can have a stiffness similar to fabric, whereas THERMOBALLISTIC ballistic sheets can have a stiffness similar to a paper business card. When cutting one or more K-FLEX ballistic sheets, cutting performance can be enhanced by grouping the one or more K-FLEX ballistic sheets with one or more THERMOBALLISTIC ballistic sheets, either on a top side only or on both a top and bottom side of the one or more K-FLEX ballistic sheets. These groupings of ballistic sheets can provide cleaner cuts with less fraying along edges of the K-FLEX ballistic sheets. Reducing fraying along edges of the cut sheets can help ensure that the performance of the sheets is not degraded and that a ballistic apparatus constructed from the ballistic sheets performs as intended.

Examples of stacks 650 of ballistic sheets 600 suitable for cutting on a cutting table 110 include the following configurations, where the first listed grouping in each stack 650 is in closest proximity to the top surface 111 of the cutting table 110, and the last listed grouping in each stack is farthest from the top surface of the cutting table: 1-6 THERMOBALLISTIC 0/90 x-ply ballistic sheets, 1-10 K-FLEX 0/90 x-ply ballistic sheets, 1-6 THERMOBALLISTIC 0/90 x-ply ballistic sheets; 1-5 THERMOBALLISTIC 0/90 x-ply ballistic sheets, 1-10 K-FLEX 0/90 x-ply ballistic sheets, 1-5 THERMOBALLISTIC 0/90 x-ply ballistic sheets; 1-4 THERMOBALLISTIC 0/90 x-ply ballistic sheets, 1-10 K-FLEX 0/90 x-ply ballistic sheets, 1-4 THERMOBALLISTIC 0/90 x-ply ballistic sheets; 1-3 THERMOBALLISTIC 0/90 x-ply ballistic sheets, 1-10 K-FLEX 0/90 x-ply ballistic sheets, 1-3 THERMOBALLISTIC 0/90 x-ply ballistic sheets; 1-2 THERMOBALLISTIC 0/90 x-ply ballistic sheets, 1-10 K-FLEX 0/90 x-ply ballistic sheets, 1-2 THERMOBALLISTIC 0/90 x-ply ballistic sheets; 1 THERMOBALLISTIC 0/90 x-ply ballistic sheets, 1-10 K-FLEX 0/90 x-ply ballistic sheets, 1 THERMOBALLISTIC 0/90 x-ply ballistic sheets; 6 THERMOBALLISTIC 0/90 x-ply ballistic sheets, 10 K-FLEX 0/90 x-ply ballistic sheets, 6 THERMOBALLISTIC 0/90 x-ply ballistic sheets; 6 THERMOBALLISTIC 0/90 x-ply ballistic sheets, 8 K-FLEX 0/90 x-ply ballistic sheets, 6 THERMOBALLISTIC 0/90 x-ply ballistic sheets; or 1 or more THERMOBALLISTIC 0/90 x-ply ballistic sheets, 1 or more K-FLEX 0/90 x-ply ballistic sheets, 1 or more THERMOBALLISTIC 0/90 x-ply ballistic sheets.

Additional examples of stacks 650 of ballistic sheets 600 suitable for cutting on a cutting table are provided below, where a first plurality of ballistic sheets (e.g. one or more K-FLEX 0/90 x-ply ballistic sheets) are bounded by a second plurality of ballistic sheets (e.g. one or more THERMOBALLISTIC 0/90 x-ply ballistic sheets). In the following examples, the first listed grouping in each stack is in closest proximity to the top surface of the cutting table: 1-6 K-FLEX 0/90 x-ply ballistic sheets, 1-6 THERMOBALLISTIC 0/90 x-ply ballistic sheets; 1-4 K-FLEX 0/90 x-ply ballistic sheets, 1-6 THERMOBALLISTIC 0/90 x-ply ballistic sheets; 2-4 K-FLEX 0/90 x-ply ballistic sheets, 3-6 THERMOBALLISTIC 0/90 x-ply ballistic sheets; 3-4 K-FLEX 0/90 x-ply ballistic sheets; 4-6 THERMOBALLISTIC 0/90 x-ply ballistic sheets; 3 K-FLEX 0/90 x-ply ballistic sheets, 6 THERMOBALLISTIC 0/90 x-ply ballistic sheets; 4 K-FLEX 0/90 x-ply ballistic sheets, 6 THERMOBALLISTIC 0/90 x-ply ballistic sheets.

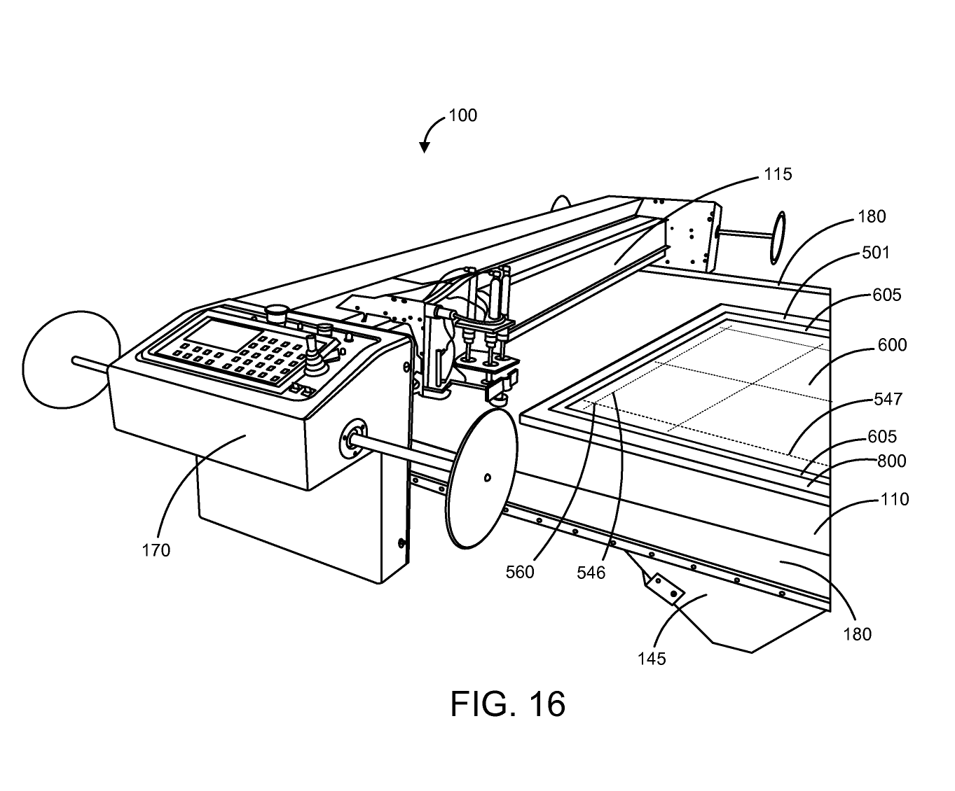

In some examples, the stack 650 of materials 600, such as a stack of ballistic sheets 600, can be cut without using a buffer layer 500, as shown in FIGS. 16 and 17. In some example, the top surface 111 of the cutting table can be made of POREX, a porous polymer material. POREX, and other cutting table materials, can be costly to replace if damaged by a cutting process or through misuse. A less expensive protective layer 800, such as a polymer sheet, can be used to cover and protect the top surface of the cutting table 110. For instance, a thermoplastic polycarbonate sheet 800 (e.g. a LEXAN sheet) can be used to cover and protect the top surface 111 of the cutting table 110. The protective layer 800 can include a plurality of holes 805 that permit air to pass through the layer and allow suction to be created proximate a top surface of the protective layer. If the protective layer 800 is damaged during a cutting process, it can be replaced at a much lower cost than POREX or other costly cutting table materials. Due to its machinability, a protective layer 800 made of thermoplastic polycarbonate can permit an operator to easily drill or create any suitable hole pattern in the protective layer. The number, size, or configuration of the plurality holes 805 can vary depending on the pattern to be cut from the ballistic sheet 600 or stack 650 of sheets. This provides the operator with additional process flexibility that can enhance cutting performance. For example, the protective layer 800 can be modified to intentionally cover and obstruct certain air holes 120 in the cutting table (similar to the air dams 810 of the buffer layer 500 shown in FIG. 8), thereby increasing the suction proximate the remaining unobstructed air holes. If the operator is cutting two patterns on the same cutting table in a single day, the operator can have two protective layers 800 that are each optimized for cutting one of the two patterns. For instance, a first protective layer 800 can have a number, size, and configuration of holes 805 that is optimized for a first pattern, and a second protective layer 800 can have a number, size, and configuration of holes that is optimized for a second pattern.

As shown in FIG. 17, the stack 650 of materials 600 can be cut directly on the protective layer 800 resting on top of the cutting table 110 without using a buffer layer 500. To ensure a complete cut of the bottommost layer of material 600 in the stack 650, the tip 141 of the cutting tool 140 (e.g. drag knife) may be set to a cutting depth that results in slight scoring of the top surface of the protective layer 800 by the tip of the cutting tool. In some examples, as shown in FIG. 16, the perimeter of the material 600 can be secured with tape 605. Alternately, any other suitable adhesive, clamping device, or fasteners, can be used in conjunction with the vacuum system or instead of the vacuum system to hold the material 600 in place during the cutting process. As discussed above, the stack 650 of materials 600, as shown in FIG. 17, can include a first grouping of one or more ballistic sheets that are less stiff bounded on a top surface by a second grouping of one or more ballistic sheets that are stiffer. In another example, a first grouping of one or more ballistic sheets 600 that are less stiff can be bounded on a top surface and a bottom surface by a second and third grouping, respectively, of one or more ballistic sheets that are stiffer than the less stiff ballistic sheets.

The buffer layer 500 can be equipped for use with a cutting table 110 equipped with a vacuum system. The buffer layer 500 can include a first surface and a second surface opposite the first surface. The second surface of the buffer layer 500 can be adapted to rest against a top surface 111 of the cutting table 110. The first surface of the buffer layer 500 can be adapted to receive a material to be cut 600. The buffer layer 500 can include a channel 505 disposed in the first surface of the buffer layer. The channel 505 can correspond to a pattern to be cut from the material 600. The channel 505 can have a depth that is configured to provide a clearance depth 705 between a tip 141 of a cutting tool 140 associated with the cutting table 110 and a bottom surface 506 of the channel. The buffer layer 500 can include a plurality of air passages 125 extending from the first surface of the buffer layer to the second surface of the buffer layer. The plurality of air passages 125 can be adapted to permit airflow through the buffer layer 500 from the first surface of the buffer layer to the second surface of the buffer layer and into the vacuum system of the cutting table 110.

The buffer layer 500 can include a support region 630 proximate a top edge of the channel 505 in the buffer layer. The support region 630 can be adapted to receive the material 600 to be cut. The support region 630 can be adapted to support the material 600 and resist downward deflection of the material into the channel 500 when downward pressure is applied against the material by the tip 141 of the cutting tool 140 during a piercing process, as shown in FIG. 10A.

The cutting table assembly 100 can be equipped with a cutting head 130 from which the cutting tool 140 extends. In some examples, a width of the channel 505 in the buffer layer 500 can be less than a width of the cutting head 130. The clearance depth 705 between the tip 141 of the cutting tool 140 and the bottom surface 506 of the channel 505 can be at least 0.02 inch.

In some examples, the buffer layer 500 can be made of an engineered wood product. In other examples, the buffer layer 500 can be a 3D printed buffer layer. The buffer layer 500 can include a cavity 805 extending into the second surface of the buffer layer, where the cavity is adapted to permit a first air passage of the plurality of air passages 125 to be in fluid communication with a first hole of the plurality of holes 120 in the cutting table 110 when the first air passage and the first hole are misaligned. In some examples, the buffer layer 500 can include a filter layer proximate the second surface of the buffer layer, and the filter layer can be configured to capture cutting remnants. The material 600 to be cut can be, for example, a carbon-fiber reinforced polymer, a glass-fiber reinforced polymer, or a stack of two or more ballistic sheets. The buffer layer 500 can include a finger recess 520 in the first surface of the buffer layer. The finger recess 520 can be configured to allow a finger of a user to be inserted beneath an edge of the material 600 to be cut to permit the material to be lifted more easily from the buffer layer when the vacuum system is operating.

A method for cutting a material 600 on a cutting table 110 while preventing a cutting tool 140 from contacting a top surface 111 of the cutting table can include several steps. The method can include providing a cutting table 110 having a top surface 111 and a bottom surface 112 opposite the top surface. The cutting table 110 can include plurality of holes 120 extending from the top surface 111 to the bottom surface 112. The cutting table 110 can include a plenum 145 in fluid communication with the bottom surface 111 of the cutting table 110 and a vacuum pump 160 in fluid communication with the plenum 145. The vacuum pump 160 can be adapted to produce a partial vacuum in the plenum 145 while operating and, as a result of the partial vacuum, can draw air downward through the plurality of holes 120 in the cutting table 110. The method can include providing a buffer layer 500 positioned on the top surface 111 of the cutting table 110. The buffer layer 500 can include a first surface and a second surface opposite the first surface. The second surface of the buffer layer 500 can be adapted to rest against the top surface 111 of the cutting table 110. The first surface of the buffer layer 500 can be adapted to receive the material to be cut 600. The buffer layer 500 can include a channel 505 in the first surface of the buffer layer. The channel 505 can correspond to a pattern to be cut from the material 600. The channel 505 can have a depth adapted to provide a clearance depth 705 between a cutting tool 140 and a bottom surface 506 of the channel while the pattern is being cut from the material 600. The buffer layer 500 can include a plurality of air passages 125 extending from the first surface of the buffer layer to the second surface of the buffer layer. The plurality of air passages 125 can be adapted to permit airflow through the buffer layer 500 and into the plurality of holes 120 in the cutting table 110 when the vacuum system is operating.

The method can include performing a first cutting step along a first cutting pathway 546 and performing a second cutting step along a second cutting pathway 547. The first cutting pathway 546 can correspond to a first channel 505 in the buffer layer 500, and the second cutting pathway 547 can correspond to a second channel 505 in the buffer layer 500. As shown in FIGS. 10B and 10C, the first cutting pathway 546 and the second cutting pathway 547 can overlap. By performing the first cutting step and the second cutting step, a cleanly cut corner 560 can be produced in the material 600 proximate the overlap of the first and second cutting pathways (546, 547). The buffer layer 500 can include a support region 630 proximate a top edge of the channel. The support region 630 can be adapted to receive the material to be cut 600. The support region 630 can be adapted to support the material 600 and to resist downward deflection of the material into the channel 505 when downward pressure is applied by the cutting tool 140 during a piercing process. The cutting table can be equipped with a cutting head 130 from which the cutting tool 140 extends, and the width of the channel 505 in the buffer layer 500 can be less than the width of the cutting head. In some examples, the method can include securing at least a portion of a perimeter of the material to be cut 600 to the first surface of buffer layer 500 using tape or any other suitable securing device.

A sacrificial protective layer 800, as shown in FIGS. 16 and 17, can be used in conjunction with a cutting table 110 equipped with a vacuum system. The sacrificial protective layer 800 can be disposable or recyclable. The sacrificial protective layer 800 can include a first surface and a second surface opposite the first surface. The second surface of the protective layer 800 can be adapted to rest against a top surface 111 of the cutting table 110. The first surface of the protective layer 800 can be adapted to receive a material to be cut 600. The protective layer 800 can include a plurality of air passages 805 extending from the first surface of the protective layer to the second surface of the protective layer. The plurality of air passages 805 can be adapted to permit airflow through the protective layer 800 from the first surface of the protective layer to the second surface of the protective layer and into the vacuum system of the cutting table 110. The protective layer 800 can prevent the cutting tool 140 associated with the cutting table assembly 100 from directly contacting a top surface 111 of the cutting table 110, thereby protecting the top surface of the cutting table from the cutting tool and reducing wear to the cutting tool. The protective layer 800 can be made of a polymer material such as, for example, thermoplastic polycarbonate. In some examples, the protective layer can have a thickness of about 0.125-0.375 inches.

A method for cutting a stack 650 of two or more ballistic sheets 600 simultaneously on a cutting table 110 can include several steps. The method can include providing the cutting table 110. The cutting table 110 can include a top surface 111 and a bottom surface 112 opposite the top surface, a cutting tool 140 movable relative to the top surface of the cutting table, a plurality of holes 120 extending from the top surface to the bottom surface of the cutting table, a plenum 145 in fluid communication with the bottom surface of the cutting table, and a vacuum pump 160 in fluid communication with the plenum. The vacuum pump 160 can be adapted to produce a partial vacuum in the plenum while operating and can draw air through the plurality of holes 120 in the top surface of the cutting table.

The method can include providing the stack 650 of ballistic sheets 600 to be cut. The stack 650 of ballistic sheets 600 can include a first grouping of one or more ballistic sheets and a second grouping of one or more ballistic sheets. The one or more ballistic sheets in the first grouping can be stiffer than the one or more ballistic sheets in the second grouping of ballistic sheets. The stack 650 of ballistic sheets 600 can be arranged with the first grouping of ballistic sheets positioned on top of the second grouping of ballistic sheets.

The method can include providing a protective layer 800 positioned on the top surface 111 of the cutting table 110. The protective layer 800 can include a first surface and a second surface opposite the first surface. The second surface of the protective layer 800 can be adapted to rest against a top surface 111 of the cutting table 110. The first surface of the protective layer 800 can be adapted to receive and support the stack 650 of ballistic sheets to be cut 600. The protective layer 800 can include a plurality of air passages 805 extending from the first surface of the protective layer to the second surface of the protective layer. The plurality of air passages 805 can be adapted to permit airflow through the protective layer 800 from the first surface of the protective layer to the second surface of the protective layer and into the plenum 145 that is fluidly connected to the bottom surface 112 of the cutting table 110.

In some examples, the stack 650 of ballistic sheets 600 can include a third grouping of one or more ballistic sheets. The one or more ballistic sheets in the third grouping can be more stiff than the one or more ballistic sheets in the second grouping of ballistic sheets. The stack 650 of ballistic sheets 600 can be arranged with the third grouping of ballistic sheets positioned beneath the second grouping of ballistic sheets. In some examples, the method can include securing at least a portion of a perimeter of the stack 650 of ballistic sheets 600 to the first surface of the protective cover 800 using tape or any other suitable securing device.

The method can include setting a cutting depth for the cutting tool 140 that results in slight scoring of the first surface of the protective layer 800 by a tip 141 of the cutting tool during a cutting process to ensure a complete cut of a bottommost ballistic sheet in the stack of ballistic sheets. In this sense, “complete cut” means that the fibers of the ballistic sheet are completely severed along the cutting pathway.

The method can include performing a first cutting step along a first cutting pathway 546 and performing a second cutting step along a second cutting pathway 547. The first cutting pathway 546 and the second cutting pathway 547 can overlap, as shown in FIG. 17. By performing the first cutting step and the second cutting step, a cleanly cut corner 560 can be produced in the stack 650 of ballistic sheets proximate the overlap of the first and second cutting pathways (546, 547).

The foregoing description has been presented for purposes of illustration and description. It is not intended to be exhaustive or to limit the claims to the embodiments disclosed. Other modifications and variations may be possible in view of the above teachings. The embodiments were chosen and described to explain the principles of the invention and its practical application to enable others skilled in the art to best utilize the invention in various embodiments and various modifications as are suited to the particular use contemplated. It is intended that the claims be construed to include other alternative embodiments of the invention except insofar as limited by the prior art.

What is claimed is:

1. A buffer layer for use with a cutting table equipped with a vacuum system, the buffer layer comprising:
a first surface and a second surface opposite the first surface, wherein the second surface of the buffer layer is adapted to rest against a top surface of the cutting table, and wherein the first surface of the buffer layer is adapted to receive a material to be cut;
a channel disposed in the first surface of the buffer layer, the channel corresponding to a pattern to be cut from the material, wherein the channel has a depth that is configured to provide a clearance depth between a tip of a cutting tool associated with the cutting table and a bottom surface of the channel; and
a plurality of air passages extending from the first surface of the buffer layer to the second surface of the buffer layer, wherein the plurality of air passages are adapted to permit airflow through the buffer layer from the first surface of the buffer layer to the second surface of the buffer layer and into the vacuum system of the cutting table.

2. The buffer layer of claim 1, further comprising a support region proximate a top edge of the channel in the buffer layer, wherein the support region is adapted to receive the material to be cut, and wherein the support region is adapted to support the material and resist downward deflection of the material into the channel when downward pressure is applied against the material by the tip of the cutting tool during a piercing process.

3. The buffer layer of claim 2, wherein the cutting table is equipped with a cutting head from which the cutting tool extends, wherein a width of the channel in the buffer layer is less than a width of the cutting head.

4. The buffer layer of claim 3, wherein the clearance depth between the tip of the cutting tool and the bottom surface of the channel is at least 0.02 inch.

5. The buffer layer of claim 1, wherein the buffer layer comprises an engineered wood product.

6. The buffer layer of claim 1, wherein the buffer layer is a 3D printed buffer layer.

7. The buffer layer of claim 1, further comprising a cavity extending into the second surface of the buffer layer, wherein the cavity is adapted to permit a first air passage of the plurality of air passages to be in fluid communication with a first hole of the plurality of holes in the cutting table when the first air passage and the first hole are misaligned.

8. The buffer layer of claim 1, wherein the cutting tool is a drag knife.

9. The buffer layer of claim 1, wherein the material to be cut is a carbon-fiber reinforced polymer, a glass-fiber reinforced polymer, or a stack of two or more ballistic sheets.

10. The buffer layer of claim 9, further comprising a filter layer proximate the second surface of the buffer layer, the filter layer configured to capture cutting remnants.

11. The buffer layer of claim 1, further comprising a finger recess in the first surface of the buffer layer, the finger recess configured to allow a finger to be inserted beneath an edge of the material to permit the material to be lifted more easily from the buffer layer when the vacuum system is operating.

12. A method for cutting a material on a cutting table while preventing a cutting tool from contacting a top surface of the cutting table, the method comprising:
providing a cutting table comprising:
a top surface and a bottom surface opposite the top surface; plurality of holes extending from the top surface to the bottom surface; a plenum in fluid communication with the bottom surface of the cutting table; a vacuum pump in fluid communication with the plenum, wherein the vacuum pump is adapted to produce a partial vacuum in the plenum while operating and draw air downward through the plurality of holes in the cutting table; and
providing a buffer layer positioned on the top surface of the cutting table, the buffer layer comprising:
a first surface and a second surface opposite the first surface, wherein the second surface of the buffer layer is adapted to rest against the top surface of the cutting table, and wherein the first surface of the buffer layer is adapted to receive the material to be cut;
a channel in the first surface of the buffer layer, the channel corresponding to a pattern to be cut from the material, wherein the channel has a depth adapted to provide a clearance depth between a cutting tool and a bottom surface of the channel while the pattern is being cut from the material; and
a plurality of air passages extending from the first surface of the buffer layer to the second surface of the buffer layer, wherein the plurality of air passages are adapted to permit airflow through the buffer layer and into the plurality of holes in the cutting table when the vacuum system is operating.

13. The method of claim 12, further comprising:
performing a first cutting step along a first cutting pathway, the first cutting pathway corresponding to a first channel in the buffer layer; and
performing a second cutting step along a second cutting pathway, the second cutting pathway corresponding to a second channel in the buffer layer, wherein the first cutting pathway and the second cutting pathway overlap, and wherein by performing the first cutting step and the second cutting step, a cleanly cut corner is produced in the material proximate the overlap of the first and second cutting pathways.

14. The method of claim 12, wherein the buffer layer further comprises a support region proximate a top edge of the channel, wherein the support region is adapted to receive the material to be cut, wherein the support region is adapted to support the material and resist downward deflection of the material into the channel when downward pressure is applied by the cutting tool during a piercing process.

15. The method of claim 12, wherein the cutting table is equipped with a cutting head from which the cutting tool extends, wherein a width of the channel in the buffer layer is less than a width of the cutting head.

16. The method of claim 12, further comprising providing a clearance depth between a tip of the cutting tool and the bottom surface of the channel of at least 0.02 inch.

17. The method of claim 12, wherein the buffer layer comprises an engineered wood product.

18. The method of claim 12, further comprising a cavity extending into the second surface of the buffer layer, wherein the cavity is adapted to permit a first air passage of the plurality of air passages to be in fluid communication with a first hole of the plurality of holes in the cutting table when the first air passage and the first hole are misaligned.

19. The method of claim 12, wherein the cutting tool is a drag knife.

20. The method of claim 12, wherein the material is a carbon-fiber reinforced polymer, a glass-fiber reinforced polymer, or one or more ballistic sheets.

21. The method of claim 12, further comprising securing at least a portion of a perimeter of the material to be cut to the first surface of buffer layer using tape.

22. A sacrificial protective layer for use with a cutting table equipped with a vacuum system, the protective layer comprising:
a first surface and a second surface opposite the first surface, wherein the second surface of the protective layer is adapted to rest against a top surface of the cutting table, and wherein the first surface of the protective layer is adapted to receive a material to be cut; and
a plurality of air passages extending from the first surface of the protective layer to the second surface of the protective layer, wherein the plurality of air passages are adapted to permit airflow through the protective layer from the first surface of the protective layer to the second surface of the protective layer and into the vacuum system of the cutting table, and wherein the protective layer prevents a cutting tool associated with the cutting table from directly contacting a top surface of the cutting table thereby protecting the top surface of the cutting table from the cutting tool and reducing wear to the cutting tool.

23. The protective layer of claim 22, wherein the protective layer comprises a polymer material.

24. The protective layer of claim 23, wherein the polymer material comprises thermoplastic polycarbonate.

25. The protective layer of claim 24, wherein the protective layer has a thickness of about 0.125-0.375 inches.

26. A method for cutting a stack of two or more ballistic sheets simultaneously on a cutting table, the method comprising:
providing the cutting table comprising:
a top surface and a bottom surface opposite the top surface; a cutting tool movable relative to the top surface of the cutting table; a plurality of holes extending from the top surface to the bottom surface; a plenum in fluid communication with the bottom surface of the cutting table; a vacuum pump in fluid communication with the plenum, wherein the vacuum pump is adapted to produce a partial vacuum in the plenum while operating and draw air through the plurality of holes in the top surface of the cutting table;
providing the stack of ballistic sheets to be cut, the stack of ballistic sheets comprising a first grouping of one or more ballistic sheets and a second grouping of one or more ballistic sheets, wherein the one or more ballistic sheets in the first grouping are more stiff than the one or more ballistic sheets in the second grouping of ballistic sheets, wherein the stack of ballistic sheets is arranged with the first grouping of ballistic sheets positioned on top of the second grouping of ballistic sheets; and
providing a protective layer positioned on the top surface of the cutting table, the protective layer comprising:
a first surface and a second surface opposite the first surface, wherein the second surface of the protective layer is adapted to rest against a top surface of the cutting table, and wherein the first surface of the protective layer is adapted to receive and support the stack of ballistic sheets to be cut; and
a plurality of air passages extending from the first surface of the protective layer to the second surface of the protective layer, wherein the plurality of air passages are adapted to permit airflow through the protective layer from the first surface of the protective layer to the second surface of the protective layer and into the plenum that is fluidly connected to the cutting table.

27. The method of claim 26, wherein the stack of ballistic sheets further comprises a third grouping of one or more ballistic sheets, wherein the one or more ballistic sheets in the third grouping are more stiff than the one or more ballistic sheets in the second grouping of ballistic sheets, and wherein the stack of ballistic sheets is arranged with the third grouping of ballistic sheets positioned beneath the second grouping of ballistic sheets.

28. The method of claim 26, further comprising securing at least a portion of a perimeter of the stack of ballistic sheets to the first surface of the protective cover using tape.

29. The method of claim 26, further comprising setting a cutting depth for the cutting tool that results in slight scoring of the first surface of the protective layer by a tip of the cutting tool during a cutting process to ensure a complete cut of a bottommost ballistic sheet in the stack of ballistic sheets.

30. The method of claim 26, further comprising:
performing a first cutting step along a first cutting pathway; and
performing a second cutting step along a second cutting pathway, wherein the first cutting pathway and the second cutting pathway overlap, and wherein by performing the first cutting step and the second cutting step, a cleanly cut corner is produced in the stack of ballistic sheets proximate the overlap of the first and second cutting pathways
